(19) United States
(12) Patent Application Publication
(10) Pub. No.: US 2003/0187826 A1
(43) Pub. Date: Oct. 2, 2003

(54) Collection system database architecture

(75) Inventors: Amy Kennedy, Richmond, VA (US); Ken Couch, Muncie, IN (US); Doug Read, Dunkirk, IN (US)

Correspondence Address: Thomas A. Walsh, Ice Miller, One American Square, Box 82001, Indianapolis, IN, 46282-0002, US

(73) Assignee: Ontario Corporation, Muncie, IN

(21) Appl. No.: 10/292,794

(22) Filed: Nov. 12, 2002

Related U.S. Application Data
(60) Provisional application No. 60/368,362, filed on Mar. 28, 2002.

(51) Int. Cl. G06F 7/00

(52) U.S. Cl. 707/1

(57) ABSTRACT

A data model for an automated collection system. In an embodiment of the data model of the present invention represent an account is represented by a record in a first data structure, one or more accountholders each is represented by a record in a second data structure, and a third data structure is provided to contain records representing the connection or relationship between the accountholder and the account.

### RELATED APPLICATION

This non-provisional application claims the benefit of U.S. Provisional Patent Application Serial No. 60/368,362, filed Mar. 28, 2002, the disclosure of which is hereby incorporated herein in its entirety.

### BACKGROUND

The field of receivables management is concerned with collecting the outstanding or delinquent balance of an account and/or managing an account so that it becomes (or stays) current. With ever-increasing volumes of accounts to be managed, account collection representatives need to do the work that will be most effective. Usually this means the work that is likely to result in cash receipts in the shortest period of time or with the smallest amount of effort.

Early collection systems consisted of a series of index cards, wherein each index card represented an account that needed to be worked so that a balance could be collected. In the early 1980's, automated collection systems started to become popular. These computerized systems directly replaced the index cards used by most collection offices. One such system, the FACS® system, was released during this time period by Ontario Systems, a subsidiary of the assignee of the present invention. The FACS® system adopted a data model which replaced the physical index card system with a computerized system in which accounts are represented by records in a computer database. The primary FACS® system database table was the Account Table, which contained one record for each account. Thus, while the FACS® system (and systems like it) automated the manual index card system known in the art, it did not significantly alter the underlying data model or processes.

Later, the FACS® system made an advance in being able to link accounts together if they were for the same accountholder. This linking made the account collection representative more effective, since he could speak to an accountholder about multiple accounts during a single telephone call. The FACS® system also added a feature through which an account collection representative could link and see multiple accounts for the same accountholder, even if the accounts were in different stages in the life-cycle of a delinquent account. For example, a newly opened account would not be in the same “stage” of the account life cycle as an account that had been referred to an attorney for collection litigation, yet both were visible to an account collection representative.

Despite the advancements in features of automated collection systems, there has been little change in the data model underlying collection systems. The Account Table remains the primary working data structure in collection systems known in the art. This traditional data model has several shortcomings. First, the traditional data model is not easily adapted to accounts having more than one accountholder. Because there is only one account record reflecting the obligation of a plurality of accountholders, separate treatment of the individual accountholders is difficult. For example, if a debt is the subject of collection litigation in which multiple judgments are obtained and each defendant makes a separate payment arrangement to satisfy his or her portion of the judgment, these separate payment arrangements cannot be tracked individually in the traditional data model. Similarly, when the account record contains no current address and/or telephone number for one of the plurality of accountholders, the entire account often will be sent to “skip tracing” in an attempt to locate such information, even though the address and telephone number information about other accountholders may be available. Finally, tracking contacts and history of conversations with individual accountholders of a multiple-debtor account is difficult in the traditional data model. Frequently, account collection representatives must rely on companion manual records in situations where one account record in the database reflects the obligations of a plurality of accountholders.

A traditional data model also requires complicated programming to manage the different aspects of an account. For example, tracking progress in the special cases of healthcare insurance claims and collection lawsuits is difficult in the traditional data model. Frequently, healthcare insurance claims and collection lawsuits are treated as additional fields in the Account Table of a collection system comprising the traditional data model. This technique often introduces difficulty when there is more than one healthcare insurance claims or collection lawsuits per account. In addition, using this technique makes it difficult to separately track the progress of the healthcare insurance claim or collection lawsuit versus the progress of the underlying account. Thus, the system must be configured to manage two distinct collection processes for the same central data structure, which requires complicated programming in the traditional data model.

Similarly, the other data structures, data elements, and processes created for special cases such as healthcare insurance claims and collection litigation require that certain automated functions programmed for the Account Table (such as automatic letter creation, telephone dialer routines, and the like), must be re-written to adapt to the data structure, data elements, and processes of the other database tables specific to the special cases of healthcare insurance claims and collection litigation.

For the foregoing reasons, there is a need for a new data model for automated collection systems. A desired data model will overcome the shortcomings of the traditional data model and provide more flexibility for account collection representatives and those who develop and maintain automated collection systems. Further, a desired data model will be adaptable to apply to other industries.

### SUMMARY

The present invention comprises a data model for an automated collection system. The data model of the present invention overcomes the shortcomings of a traditional automated collection system data model by representing automated collection system data in a novel way.

In an embodiment, the present invention comprises a method of implementing a debt collection process using a computer having a memory, the method comprising the step of providing a first data structure in the computer memory, the first data structure comprising an account record, the account record comprising information about a debt; the step of providing a second data structure in the computer memory, the second data structure comprising at least one accountholder record, each of the at least one accountholder records comprising information about a debtor that may be obligated to pay the debt; the step of providing a third data structure in the computer memory; and the step of processing the account information to create, in the third data structure, an account management record, the account management record comprising information related to the account record.

An aspect of this embodiment of the present invention further comprises the step of processing the accountholder information and the account information to link the accountholder information to the account information in the third data structure, the third data structure thereafter comprising relationship data about one or more relationships between the account record and the at least one accountholder records. This aspect of this embodiment of the present invention may further comprise the step of creating, in the third data structure, an account/accountholder record, the account/accountholder record comprising information related to the account record and one of the at least one accountholder records.

In an aspect of this embodiment of the present invention wherein the debt is a healthcare debt for which a healthcare insurance payer may be obligated to pay pursuant to a healthcare insurance plan, and wherein the second data structure comprises at least one accountholder record comprising information about the healthcare insurance payer, the present invention further comprises the step of providing a fourth data structure in the memory, the fourth data structure comprising at least one healthcare insurance plan record comprising information about the healthcare insurance plan; and the step of processing the healthcare insurance plan information, the accountholder information about the healthcare insurance payer, and the account information to link the healthcare insurance plan information, the accountholder information about the healthcare insurance payer, and the account information in the third data structure, the third data structure thereafter comprising relationship data about one or more relationships between the account record, the at least one accountholder record comprising information about the healthcare insurance payer, and the at least one healthcare insurance plan record. This aspect of this embodiment of the present invention may further comprise the step of creating, in the third data structure, a healthcare insurance claim record, the healthcare insurance claim record comprising information related to the account record, one of the at least one accountholder record comprising information about the healthcare insurance payer, and one of the at least one healthcare insurance plan records.

In an aspect of this embodiment, the present invention further comprises the step of providing a fourth data structure in the memory, the fourth data structure comprising at least one legal case record, each of the at least one legal case records comprising information about a collection lawsuit initiated for the purpose of collecting the debt, wherein at least one of the at least one accountholders is identified as a defendant in the collection lawsuit; and the step of processing the collection lawsuit information, the accountholder information, and the account information to link the collection lawsuit information, the accountholder information, and the account information in the third data structure, the third data structure thereafter comprising relationship data about one or more relationships between the account record, the at least one accountholder records, and the at least one legal case records. This aspect of this embodiment of the present invention may further comprise the step of creating, in the third data structure, a legal case work record, the legal case work record comprising information related to the account record, one of the at least one accountholder records, and one of the at least one legal case records.

In an aspect of this embodiment, the present invention comprises the step of assigning an account management workflow to the account management record, the account management workflow comprising information pertaining to at least one account management workflow phase, wherein each of the at least one account management workflow phases is reflective of a possible step in the debt collection process, and wherein the account management workflow phase comprises an account management workflow phase variable that is capable of being assigned a value, the value assigned to the account management workflow phase variable being indicative of one of the at least one account management workflow phases. This aspect of this embodiment of the present invention may further comprise, where the account management record comprises a first work record, the step of creating a second work record in the third data structure, the second work record being created upon the account management workflow phase variable being assigned a value that is equal to a predetermined value. This aspect of this embodiment of the present invention also may further comprise, where the account management record comprises a first work record, the step of deleting a second work record in the third data structure, the second work record being deleted upon the account management workflow phase variable being assigned a value that is equal to a predetermined value. This aspect of this embodiment of the present invention also may further comprise, where the account management record comprises a first work record, the step of providing a second work record in the third data structure, the second work record comprising data; and the step of changing the data of the second work record upon the account management workflow phase variable being assigned a value that is equal to a predetermined value.

In an aspect of this embodiment wherein the third data structure comprises a plurality of work records, the present invention further comprises the step of assigning a work record workflow to one of the plurality of work records, the work record workflow comprising information pertaining to at least one work record workflow phase, wherein each of the at least one work record workflow phases is reflective of a possible step in the debt collection process, and wherein the work record workflow phase comprises a phase variable that is capable of being assigned a value, the value assigned to the phase variable being indicative of one of the at least one work record workflow phases; and the step of recording an event in the third data structure, wherein the recordation automatically changes the value of the phase variable.

In an aspect of this embodiment wherein the third data structure comprises a plurality of work records, the present invention further comprises the step of assigning a first work record workflow to a first of the plurality of work records, the first work record workflow comprising information pertaining to at least one first work record workflow phase, wherein each of the at least one first work record workflow phases is reflective of a possible step in the debt collection process, and wherein the first work record workflow phase comprises a first work record workflow phase variable that is capable of being assigned a value, the value assigned to the first work record workflow phase variable being indicative of one of the at least one first work record workflow phases; the step of assigning a second work record workflow to a second of the plurality of work records, the second work record workflow comprising information pertaining to at least one second work record workflow phase, wherein each of the at least one second work record workflow phases is reflective of a possible step in the debt collection process, and wherein the second work record workflow phase comprises a second work record workflow phase variable that is capable of being assigned a value, the value assigned to the second work record workflow phase variable being indicative of one of the at least one second work record workflow phases; and the step of changing the value of the first work record workflow phase variable, wherein the change in the value of the first work record workflow phase variable automatically causes a change in the value of the second work record workflow phase variable.

In an aspect of this embodiment wherein the third data structure comprises a plurality of work records, the present invention further comprises the step of assigning a work record workflow to one of the plurality of work records, the work record workflow comprising information pertaining to at least one work record workflow phase, wherein each of the at least one work record workflow phases is reflective of a possible step in the debt collection process, and wherein the work record workflow phase comprises a phase variable that is capable of being assigned a value, the value assigned to the phase variable being indicative of one of the at least one work record workflow phases; and the step of changing the value of the phase variable, wherein the change in the phase variable value causes an action to be performed.

In an aspect of this embodiment wherein the third data structure comprises a plurality of work records, the present invention further comprises the step of assigning a work record workflow to one of the plurality of work records, the work record workflow comprising information pertaining to at least one work record workflow phase, wherein each of the at least one work record workflow phases is reflective of a possible step in the debt collection process, and wherein the work record workflow phase comprises a phase variable that is capable of being assigned a value, the value assigned to the phase variable being indicative of one of the at least one work record workflow phases; and the step of changing the value of the phase variable, wherein the change in the phase variable value causes an action to be scheduled for future performance.

An aspect of this embodiment further comprises the step of recording an event in the third data structure, wherein the recordation automatically causes the creation of a work record. An aspect of this embodiment further comprises the step of recording an event in the third data structure, wherein the recordation automatically causes an action to be performed. An aspect of this embodiment further comprises the step recording an event in the third data structure, wherein the recordation automatically causes an action to be scheduled for future performance.

In an embodiment, the present invention comprises an automated collection system comprising a computer having a memory; a first data structure resident on the memory comprising account information about a debt; a second data structure resident on the memory comprising accountholder information about at least one debtor that may be obligated to pay the debt; a third data structure resident on the memory; and processing structure capable of creating, in the third data structure, an account management record, the account management record comprising information related to the account information.

In an aspect of this embodiment, the present invention further comprises processing structure capable of creating, in the third data structure, an account/accountholder record, the account/accountholder record comprising information about a relationship between the account information and the accountholder information about one of the debtors.

In an aspect of this embodiment wherein the debt comprises a healthcare debt, and wherein at least one of the at least one debtors is a healthcare insurance payer that is obligated to pay the healthcare debt pursuant to a healthcare insurance plan, the present invention further comprises a fourth data structure resident on the memory, the fourth data structure comprising at least one healthcare insurance plan record comprising information about the healthcare insurance plan; and processing structure capable of creating, in the third data structure, a healthcare insurance claim record, the healthcare insurance claim record comprising information about a relationship between the account information, accountholder information about one of the healthcare insurance payers, and the healthcare insurance plan information.

In an aspect of this embodiment, the present invention further comprises a fourth data structure resident in the memory, the fourth data structure comprising at least one legal case record, each of the at least one legal case records comprising information about a collection lawsuit initiated for the purpose of collecting the debt, wherein at least one of the at least one debtors is identified as a defendant in the collection lawsuit; and processing structure capable of creating, in the third data structure, a legal case work record, the legal case work record comprising information about a relationship between the account information, the accountholder information about one of the debtors, and the collection lawsuit information about one collection lawsuit.

### BRIEF DESCRIPTION OF THE DRAWINGS

FIG. 1 shows a block diagram illustrating an embodiment of an automated collection system according to the present invention.

FIGS. 2A-E show block diagrams illustrating embodiments of the data model of the present invention.

FIG. 3 shows a flow chart illustrating the operation of an embodiment of the data model of the present invention.

FIG. 4 shows a block diagram illustrating the operation of a workflow hierarchy according to an embodiment of the data model of the present invention.

FIG. 5A shows a block diagram illustrating a work record according to an embodiment of the present invention.

FIG. 5B shows a flow chart illustrating an exemplary workflow according to an embodiment of the present invention.

FIG. 6A shows a block diagram illustrating a work record according to an embodiment of the present invention.

FIG. 6B shows a flow chart illustrating an exemplary workflow according to an embodiment of the collection model of FIG. 6A.

FIG. 7A shows a block diagram illustrating the treatment of a healthcare insurance claim according to an embodiment of the present invention.

FIG. 7B shows a flow chart illustrating an exemplary workflow according to an embodiment of the present invention applied to a work record comprising a healthcare insurance claim.

FIG. 8A shows a work record according to an embodiment of the present invention representing a legal case filed in collection litigation.

FIG. 8B shows a flow chart illustrating an exemplary workflow for a legal case work record according to an embodiment of the present invention.

FIG. 9A shows a work record created for a delegated assignment according to an embodiment of the present invention.

FIG. 9B shows a flow chart illustrating an exemplary workflow for a work record representing a delegated assignment according to an embodiment of the present invention.

FIGS. 10A-D show an example of workflow interoperation according to an embodiment of the present invention.

FIG. 11A shows an entity relationship diagram illustrating an Account Holder Table, an Account Table, and a Work Table according to an embodiment of the present invention.

FIG. 11B shows the entity relationship diagram of FIG. 11A, as adapted for use in a healthcare insurance claim collection process.

FIG. 11C shows the entity relationship diagram of FIG. 11A, as adapted for collection litigation.

FIG. 11D shows the entity relationship diagram of FIG. 11A, as adapted for both healthcare insurance claims and collection litigation.

FIG. 11E shows the entity relationship diagram of FIG. 11D, as adapted to include role and workflow table information.

FIG. 11F shows an entity relationship diagram illustrating a data structure for a workflow schedule table according to an embodiment of the present invention.

FIGS. 12A-F show block diagrams illustrating examples of the operation of an embodiment of the present invention.

### DESCRIPTION

The present invention comprises a data model for an automated collection system. The data model of the present invention overcomes the shortcomings of a traditional automated collection system data model by representing automated collection system data in a novel way. The data model of the present invention provides more flexibility for account collection representatives and those who develop and maintain automated collection systems. The present invention may be adapted for a variety of receivables management or collection applications including, but not limited to, current or pre-charge-off early stage delinquencies, pre-charge-off late stage delinquencies, internal and outsourced collection efforts, charge-off, bad debt, recovery, collection litigation, probate, and bankruptcy. The present invention also is adaptable to apply to industries other than the receivables management or collection industries.

An embodiment of the data model of the present invention continues to represent each account (for example, a debt) by a record in a first data structure, such as an Account Table. However, according to the present invention, accountholders (for example, debtors) are represented by records in a second data structure comprising an Account Holder Table. A third data structure (called a “Work Table”) is introduced according to the data model of the present invention to contain records representing the “connection” or “relationship” between the accountholder and the account. As discussed in further detail hereinafter, other types of work records also are contained in the Work Table.

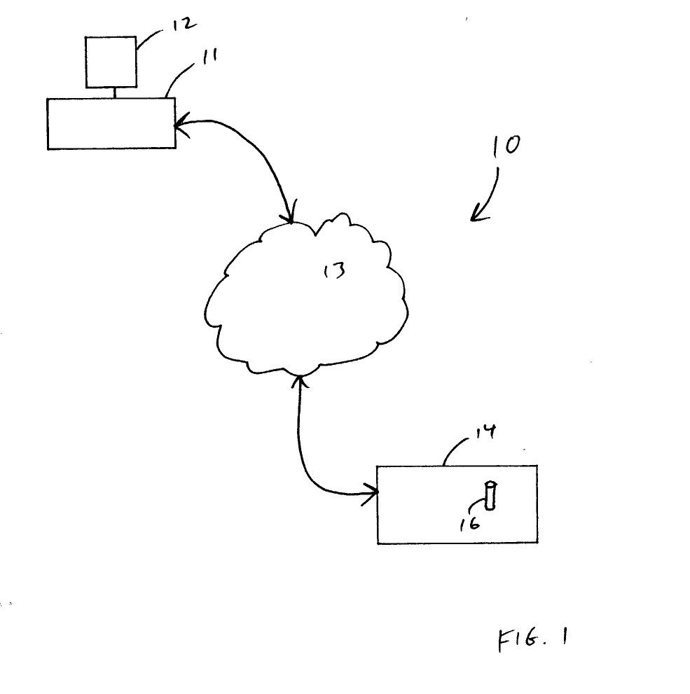

An automated collection system comprising the present invention may be configured to suit the needs of a practitioner in each particular implementation of the present invention. However, a typical embodiment of an automated collection system comprising the present invention adopts a “client-server” configuration of a type known in the art. FIG. 1 shows a block diagram of such a configuration. Shown in FIG. 1 is automated collection system 10, comprising client computer 11, video display means 12, network 13, server 14, and database 16.

Client computer 11 is a computer, computing device, or system of a type known in the art, such as a personal computer, mainframe computer, workstation, notebook computer, laptop computer, hand-held computer, wireless mobile telephone, personal digital assistant device, and the like. Client computer 11 comprises such software (operational and application), hardware, and componentry as would occur to one of skill of the art, such as, for example, one or more microprocessors, memory, input/output devices, device controllers, and the like. Client computer 11 also comprises one or more data entry means (not shown in FIG. 1) operable by a user (not shown in FIG. 1) of client computer 11, such as, for example, a keyboard, keypad, pointing device, mouse, touchpad, touchscreen, microphone, and/or other data entry means known in the art. Client computer 11 also may comprise an audio display means (not shown in FIG. 1) such as one or more loudspeakers and/or other means known in the art for emitting an audibly perceptible output. The configuration of client computer 11 in a particular implementation of an automated collection system comprising the present invention is left to the discretion of the practitioner.

Video display means 12 comprises a device upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Video display means 12 communicates electronically with client computer 11 according to hardware and software means known in the art.

For purposes of clarity, only one client computer is shown in FIG. 1. However, it is within the scope of the present invention, and it will be appreciated by those of ordinary skill in the art, that an automated collection system comprising the present invention may have two or more client computers operating concurrently. Each client computer may be operated by one or more users, such as, for example, one or more account collection representatives.

Server 14 comprises one or more server computers, computing devices, or systems of a type known in the art. Server 14 comprises a server memory, which may comprise one or more components of solid-state electronic memory, such as random access memory, as well as an electromagnetic memory such as one or more hard disk drives and/or one or more floppy disk drives or magnetic tape drives, and, optionally, an optical memory such as a Compact Disk Read Only Memory (CD-ROM) drive. Server 14 further comprises such software (operational and application), hardware, and componentry as would occur to one of skill of the art, such as, for example, microprocessors, input/output devices, device controllers, video display means, and the like.

For purposes of clarity, server 14 is shown in FIG. 1 and referred to herein as a single server. Server 14 need not, however, be a single server. Server 14 may comprise a plurality of servers or other computing devices or systems interconnected by hardware and software means known in the art which collectively are operable to perform the functions allocated to server 14 according to the present invention.

Database 16 comprises the databases and data structures discussed herein. In the embodiment shown in FIG. 1, database 16 resides in server memory on server 14. However, database 16 may resides in server memory on a server or computing device remote from server 14, provided the remote server or computing device is capable of bi-directional data transfer with server 14. Preferably, the remote server or computing device upon which database 16 resides is electronically connected to server 14 such that the remote server or computing device is capable of continuous bi-directional data transfer with server 14.

For purposes of clarity, database 16 is shown in FIG. 1 and referred to herein as a single database. It will be appreciated by those of ordinary skill in the art that database 16 may comprise a plurality of databases connected by software means, which collectively are operable to perform the functions delegated to database 16 according to the present invention. Database 16 may comprise a relational database architecture or other database architecture of a type known in the database art. Database 16 may comprise one of many well known database management systems, such as, for example, InterSystems™ Cache′™, Microsoft® SQL Server™, Microsoft® Access®, IBM® DB2®, or the database management systems available from Oracle® or Sybase®.

Server 14 is operably connected to client computer 11 by a network 13. Network 13 may comprise any means for electronically interconnecting server 14 and client computer 11 to provide for electronic communication therebetween. Thus, it will be appreciated by those of ordinary skill in the art that network 13 may comprise the Internet, the commercial telephone network, one or more local area networks, one or more wide area networks, one or more wireless communications networks, coaxial cable, fiber optic cable, twisted-pair cable, the equivalents of any of the foregoing, or the combination of any two or more of the foregoing. In an embodiment where server 14 and client computer 11 comprise a single computing device operable to perform the functions delegated to both server 14 and client computer 11 according to the present invention, network 13 comprises the hardware and software means interconnecting server 14 and client computer 11 within the single computing device.

In operation of automated collection system 10, information from database 16 is accessed by a user (such as an account collection representative) using client computer 11, according to aspects of a client-server configuration that are known in the art. Such information may be displayed on video display means 12. Data entered by a user using data entry means of client computer 11 may be stored in database 16 in server memory on server 14. Those of skill in the art will appreciate that the various data structure manipulations and automated collection system functions and operations described herein and recited in the claims may be performed by computer software and/or computer hardware programmed and configured to achieve the desired results. Such computer software may be written in a programming language known in the art.

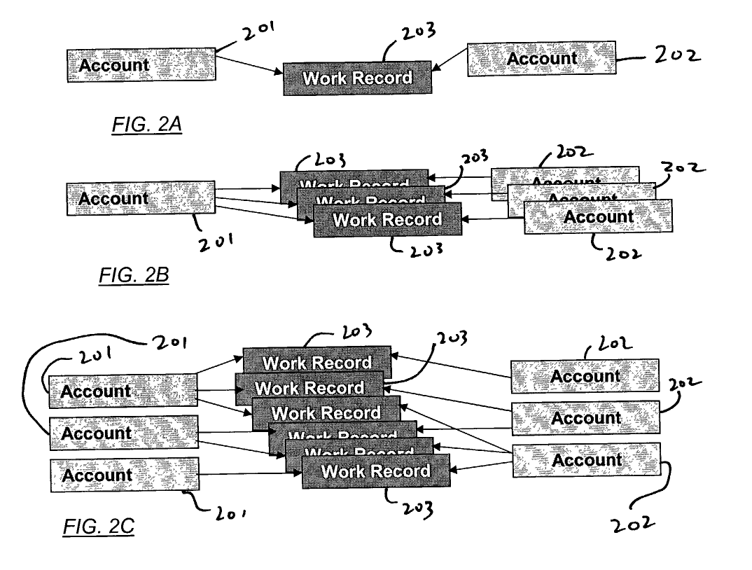

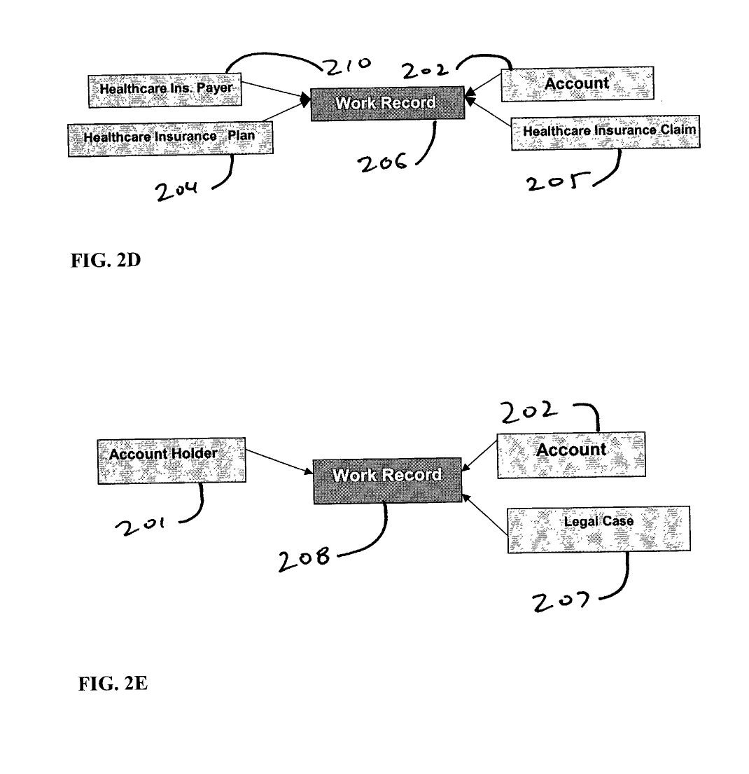

FIGS. 2A-C show block diagrams, each illustrating an implementation of a basic embodiment of the data model of the present invention. Shown in FIG. 2A are accountholder record 201, account record 202, and account/accountholder work record 203. Work record 203 comprises data pertaining to the relationship between the account information represented in account record 202 and the accountholder information represented in accountholder record 201. The block diagram shown in FIG. 2A represents a single account—single accountholder situation.

FIG. 2B shows a more complex situation wherein a single accountholder is obligated on more than one account. Shown in FIG. 2B are accountholder record 201, a plurality of account records 202, and a plurality of account/accountholder work records 203. Each work record 203 comprises data pertaining to the relationship between the account information represented in an account record 202 and the accountholder information represented in accountholder record 201.

FIG. 2C shows an even more complex situation wherein a plurality of accountholders are obligated on a plurality of accounts. Shown in FIG. 2C are a plurality of accountholder records 201, a plurality of account records 202, and a plurality of account/accountholder work records 203. Each work record 203 comprises data pertaining to a particular relationship between account information represented in an account record 202 and accountholder information represented in an accountholder record 201.

Accordingly, the data model of the present invention allows a simple representation of the complex relationships between accountholders and their financial obligations (i.e., the accounts). It also deals more efficiently with the case in which a single account has multiple co-responsible accountholders, because each relationship between an accountholder and an account is represented by an individual record in the Work Table. However, although they are represented by a plurality of individual Work Table records, the plurality of individual Work Table records for the multiple accountholders related to a single account may be linked together for working. Optionally, linking can extend to a work record comprising information about the spouse of an accountholder, since the marriage relationship may carry legal significance in certain financial obligations. Efficiency also may be enhanced in situations where a single accountholder may be responsible for more than one account, charge, or invoice, because a plurality of work records pertaining to multiple accounts for a single person may be linked together for working. The concept of linking two or more work records together is called “tying” according to the present invention. In an embodiment of the present invention, tying is permitted when work records have the same accountholder, or if two work records have different accountholders, but the different accountholders are spouses.

The Work Table is the primary data structure an automated collection system according to the present invention uses internally to organize the work of account collection representatives, and to recognize and track relationships among accountholders and accounts. In this way, the data model of the present invention focuses not only on managing accounts, but also provides focus to managing contacts with, and collection activity for, each accountholder (or entities who act on their behalf such as attorneys or healthcare insurance payers) and their financial responsibilities.

The present invention may be integrated with one or more contact facilitation tools such as, for example, a telephone dialer, an e-mail tool, a faxing tool, a web chat tool, a voice-over-IP (“VoIP”) tool, a web collaboration tool, or other contact management tools known in the art. By integrating a contact facilitation tool with an automated collection system comprising the data model of the present invention, an account collection representative can be connected to an accountholder by a communication medium (such as by telephone where a telephone dialer is used), and then the account collection representative can be presented on a computer screen with the contact information for the accountholder being contacted and that accountholder's financial responsibility for one or more account(s). An account collection representative can prioritize work according to criteria about individual accountholders. Letters or statements can be automatically prepared by the present invention to be sent to accountholders regarding their financial responsibility. Similarly, payment arrangement agreements can be created for accountholders and recorded and tracked using the present invention.

The benefits derived from separating accountholders and accounts in an automated collection system database, and focusing on the relationship between the accountholders and the accounts include:

Creation of persistent and growing data assets regarding accountholders that outlive the accounts. In the traditional data model, data about accountholders frequently was lost when the account record was extinguished due to payment or other termination of the collection activity.

Ability to contact and record collection activity for each person (or business) named on a single account individually—with no system limitations to the number of persons named on an account, or the number of accounts managed for a single person as was the case in the prior art.

Ability to prioritize work by criteria that combine attributes of the accountholder (likelihood to pay, availability of a good phone number and/or address, someone who has paid in the past, etc.) with attributes of the account (high balance, recently acquired account, etc.), to create a collection situation with a high probability of success.

Ability to display data on a computer screen, wherein such data pertains to the exact contact with whom an account representative is working and the accounts about which the conversation is taking place.

The data model of the present invention also accommodates additional information about the account as the recovery of the account balance is pursued. For example, in the healthcare industry, collection offices create or follow up on healthcare insurance claims that are sent to healthcare insurance payers on behalf of the patient. However, the underlying healthcare account showing the patient/accountholder as the debtor is not extinguished when a healthcare insurance claim is filed. Additional data representation is necessary to manage one or more healthcare insurance claims related to a single healthcare account. According to the present invention, the healthcare insurance payer is represented as another accountholder. The relationship of healthcare insurance payer (as an accountholder) and a healthcare insurance plan to a healthcare insurance claim may be represented in a record in the Work Table. Database records representing healthcare insurance plans are added in a supplemental database table. At least one record is created in the Work Table reflecting the relationship between the healthcare insurance claim and the healthcare account, the healthcare insurance payer, and the healthcare insurance plan.

FIG. 2D shows a block diagram illustrating an implementation of an embodiment of the data model of the present invention where a healthcare insurance claim has been filed with a healthcare insurance plan. Shown in FIG. 2D are account record 202, healthcare insurance plan record 204, healthcare insurance claim record 205, healthcare insurance claim work record 206, and healthcare insurance payer record 210. Work record 206 comprises data pertaining to the relationship between the accountholder information represented in healthcare insurance payer record 210, the account information represented in account record 202, the healthcare insurance plan information in healthcare insurance plan record 204, and the healthcare insurance claim information in healthcare insurance claim record 205.

In the collection litigation arena, collection offices and collection attorneys may take legal action against debtors in the courts. However, the original debt between the accountholder and the creditor is not extinguished when a collection lawsuit is filed. Again, additional data representation is necessary to manage one or more legal cases related to a single account. The relationships of accountholder(s) and legal cases can be represented by records in the Work Table.

FIG. 2E shows a block diagram illustrating an implementation of an embodiment of the data model of the present invention where a legal case has been instituted against a debtor. Shown in FIG. 2E are accountholder record 201, account record 202, legal case record 207, and legal case work record 208. Work record 208 comprises data pertaining to the relationship between the accountholder information represented in accountholder record 201, the account information represented in account record 202, and the legal case information in legal case record 207.

The data model of the present invention extends core automated collection system functionality (such as automated letters, collection activity recording, creating collection assignments, automated workflow functions, dialing methods, recording notes, and posting payments) to supplemental collection processes (such as healthcare insurance claims and collection litigation), without extra development, training, or support efforts. These additional collection processes may be coincident with the primary collection model to support complex recovery programs within a single implementation of an automated collection system according to the present invention.

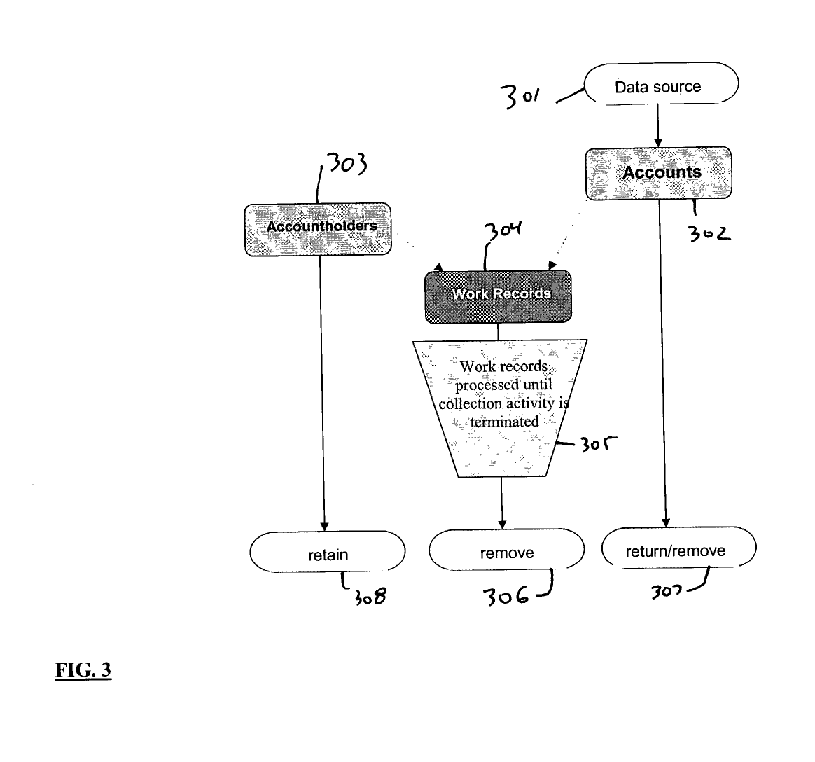

FIG. 3 shows a flow chart illustrating the operation of an embodiment of an automated collection system comprising the data model of the present invention. In the step shown as block 301 of FIG. 3, new accounts are received from a data source. In the step shown as block 302, new account records are created in the Account Table for each new account received from the data source. Accounts records may be created in the Account Table by variety of methods including, but not limited to, electronic data interchange with the data source, or manual data entry based on verbal or written information from the data source.

Next, in the step shown as block 303 of FIG. 3, a record for each accountholder on the account is identified in the Account Holder Table. An attempt is made to match accountholder(s) on incoming accounts with existing accountholder entries in the Account Holder Table. New accountholder record(s) is/are created in the Account Holder Table if no match is found.

Work records are created in the Work Table in the step shown as block 304. For each accountholder on the account, an “account/accountholder” work record is created in the Work Table. In addition, for each new account, an “account management” work record is created in the Work Table. Thus, for each new account, at least two work records are created in the Work Table.

In the step shown as block 305 of FIG. 3, the work records in the Work Table are processed until collection activity is terminated, such as if the debt is paid by the debtor, or if the debt is written off as uncollectible by the creditor. When the work on an account is completed and an account collection representative wishes to reclaim storage space taken by the now inactive account, the account record and all of the work records may be removed from the database or retrievably stored in an archival data storage location. This is shown in FIG. 3 as blocks 306 and 307. The accountholder information optionally may be retained to enhance the collection efforts for future accounts, shown in FIG. 3 as block 308.

The present invention comprises a workflow toolset that allows the definition a life cycle for work items that require stages or phases to describe and manage work activity. This workflow toolset can be adapted for any type of record representing a life cycle, but this discussion is limited to receivables management and the data model of the present invention. The workflow toolset of the present invention comprises several elements including “workflows,” “phases,” “options,” “events,” and “actions.”

Upon creation, each work record is assigned a “workflow.” A work record's workflow defines the possible stages the work record in the Work Table can go through during processing. A workflow can comprise one or more subordinate workflows.

A “phase” is one stage in a workflow. Each work record comprising a phase comprises a phase variable that is capable of being assigned a value. After a workflow is assigned to a work record, the work record is assigned the initial phase of the assigned workflow, meaning that the work record's phase variable is assigned a value indicating to the automated collection system that the work record is in the initial phase. The work record then progresses from phase-to-phase through the workflow as the collection activity represented by the work record is performed. The value of the phase variable changes each time the phase changes. As discussed in more detail hereinafter, according to the present invention a workflow phase can schedule “actions” to take place immediately or at a future time; establish how an automated collection system will respond to “events” that take place (such as, for example, payment received, payment arrangement made or broken, change of address received, claim denied, legal case number entered, and the like); and specify “options” relating to functionality exercised within the scope of the phase.

An “option” is a setting or parameter that indicates how a work record will be treated by the automated collection system during normal processing. For example, an option setting may determine whether the automated collection system will allow two work records to be tied together for processing. In another example, an option setting may determine whether the automated collection system will allow a particular account to be “settled” for less than the entire outstanding balance on the account. In yet another example, an option setting may determine how an account collection representative receives credit for a payment received during the collection processing. In still another example, payment arrangement options may determine when to check for a broken payment promise (i.e., the number of grace period days beyond a payment due date); whether to allow multiple payments within a payment period to accumulate to satisfy a minimum payment amount; whether to apply overpayments in a payment period to a subsequent payment period; or whether to allow an account collection representative to forgive a payment obligation or modify a payment plan arrangement. In another example, a reactivation option may dictate to the automated collection system comprising the present invention how and if an account in an inactive status may be placed back into an active status.

An “event” is an occurrence that interrupts the normal phase-to-phase workflow of a work record. Examples of events in the debt collection context include the receipt of an unexpected payment, or the identification of a new debtor for an account. An automated collection system according the present invention comprises event handling routines. Upon the recordation of an event in an automated collection system, an appropriate event handling routine according to the present invention operates to update work record(s) associated with an account and/or to direct certain actions to occur. In one embodiment, upon the occurrence of an event, an event handling routine evaluates one or more “qualifications.” If the qualifications are satisfied, then the automated collection system updates a work records and/or causes predetermined actions to occur.

The present invention comprises two types of “actions.” The first is an “initial phase action” which occurs immediately upon the work record entering a phase for which the initial phase action is defined. “Entering” a phase means that the work record's phase variable is assigned a value indicating to the automated collection system that the work record is in the desired phase. A phase may have a plurality of initial phase actions. Initial phase actions can be performed immediately, or may be scheduled for future performance. A specific future date and/or time may be identified for scheduled initial phase actions. Alternatively, initial phase actions may be scheduled according to a date and time offset from the date and time the action accrues by entry into the phase.

The second type of action is an action which takes place upon the occurrence of an event as part of an event handling routine. One or more “event actions” may be part of an event handling routine. Such “event actions” also can be performed immediately, or may be scheduled for future performance. As with initial phase actions, a specific future date and/or time may be identified for scheduled event actions. Alternatively, event actions may be scheduled according to a date and time offset from the date and time the action accrues by occurrence of the event.

An attribute of an action further defines the action. For example, if an action comprises sending a letter, the attribute of the action may specify which letter to send. An action may have multiple attributes.

As noted previously herein, a workflow may comprise phases and/or one or more subordinate workflows. A workflow may be defined as a “parent” (more generic) workflow, or as a “child” (more specific) workflow. Options and event handling routines may be defined at the workflow level and/or at the phase level.

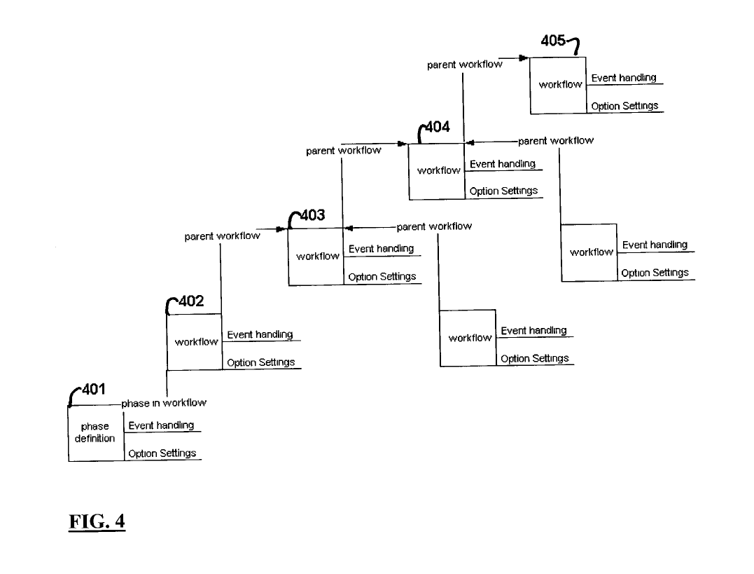

FIG. 4 shows a block diagram illustrating a workflow “hierarchy” according to an embodiment of the present invention. Shown in FIG. 4 is phase 401, which is a phase in workflow 402, which is a child of workflow 403, which is a child of workflow 404, which is a child of workflow 405. Phase 401 and workflows 402-405 have predetermined event handling routines and options. In operation, lower-level (i.e., phase level or child workflow level) event handling routines or options pre-empt higher level event handling routines or options. Thus, given a work record having workflow 402 and phase 401, if an event occurs, the present invention first evaluates the event handling routines of phase 401 to determine if an event handling routine for the event is specified for the phase. If one is not found, workflow 402 then is reviewed for an appropriate event handling routine. If workflow 402 does not specify an appropriate event handling routine, then its parent workflow, workflow 403, will be reviewed. This practice of checking parent workflows is continued until an appropriate event handling routine is found, or until the last-reviewed workflow does not specify a parent workflow.

It is important to note that, according to the present invention, workflow is applied only to the work records in the Work Table, and not to the account records in the Account Table or to accountholder records in the Account Holder Table. Applying workflow to work records in the Work Table provides the opportunity to describe the life cycles of the various aspects of an account, and to have them interoperate (as discussed hereinafter).

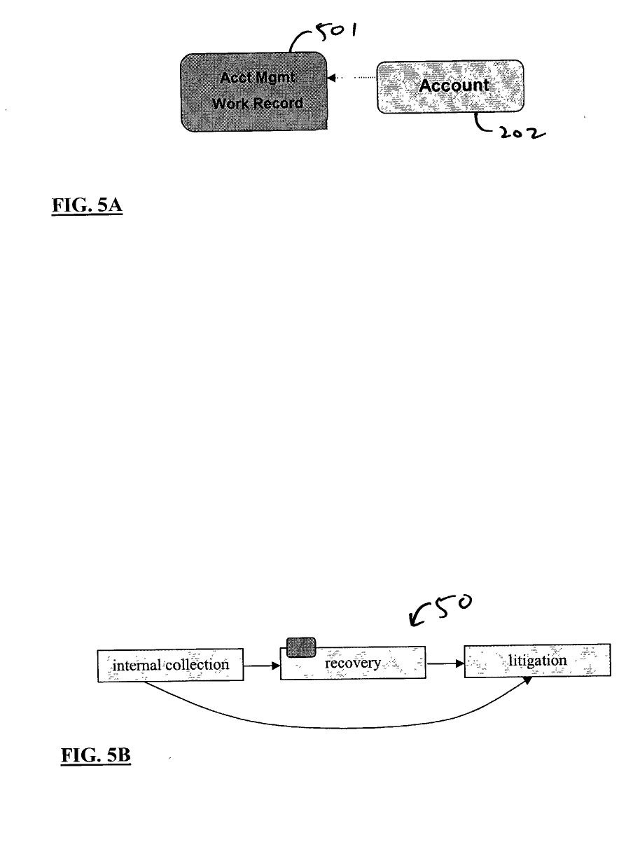

FIGS. 5A-10D illustrate the use of the workflow concepts of the present invention. It should be understood that the workflows and phases discussed herein and shown in the drawing figures hereof are merely examples, and should not be viewed as limiting the workflow and phase definitions that are possible according to the present invention. Indeed, workflows and phases may be configured by a practitioner of the present invention as the practitioner deems necessary to meet the practitioner's needs in a particular implementation of the present invention.

In a first example, an account management workflow is applied to an account management work record. FIG. 5A shows a block diagram illustrating an account management work record in the Work Table, according to an embodiment of the present invention. Shown in FIG. 5A are account record 202 and account management work record 501. Account management work record 501 comprises data pertaining to the account information represented in account record 202.

FIG. 5B shows a flow chart illustrating an exemplary account management workflow 50 that may be applied to account management work record 501 according to an implementation of the present invention. Account management workflow 50 comprises the phases of internal collection, recovery, and litigation. In account management workflow 50, the account management work record has the “internal collection” phase as its initial phase. According to account management workflow 50, the account leaves the internal collection phase by entering either the recovery phase or the litigation phase. As designated by the location of the shaded block in FIG. 5B, account management work record 501 is in the “recovery” phase of workflow 50.

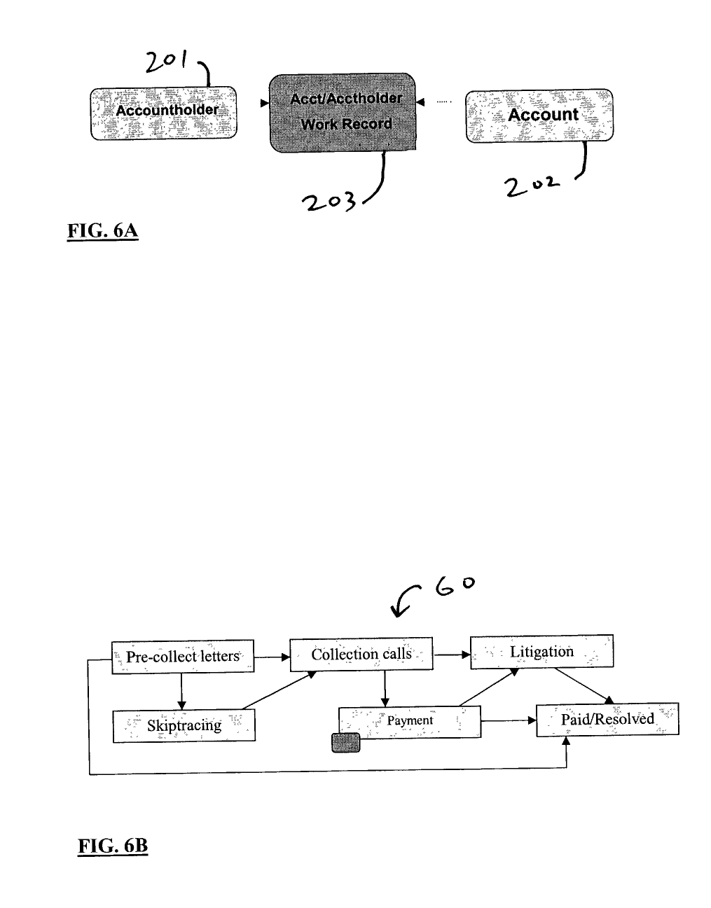

FIGS. 6A and 6B show an example of an account/accountholder workflow applied to an account/accountholder work record. Shown in FIG. 6A are accountholder record 201, account record 202, and account/accountholder work record 203. Work record 203 comprises data pertaining to the relationship between the account information represented in account record 202 and the accountholder information represented in accountholder record 201.

FIG. 6B shows a flow chart illustrating an exemplary account/accountholder workflow 60 that may be applied to account/accountholder work record 203 according to an implementation of the present invention. Account/accountholder workflow 60 comprises the phases of pre-collect letters, collection calls, skiptracing, payment arrangements, litigation, and paid/resolved. In account/accountholder workflow 60, the account/accountholder work record has the “pre-collect letters” phase as its initial phase. According to account/accountholder workflow 60, the account leaves the pre-collect letters phase by entering either the collection calls phase, the skiptracing phase, or the paid/resolved phase. As designated by the location of the shaded block in FIG. 6B, account/accountholder work record 203 is in the “payment arrangements” phase of account/accountholder workflow 60.

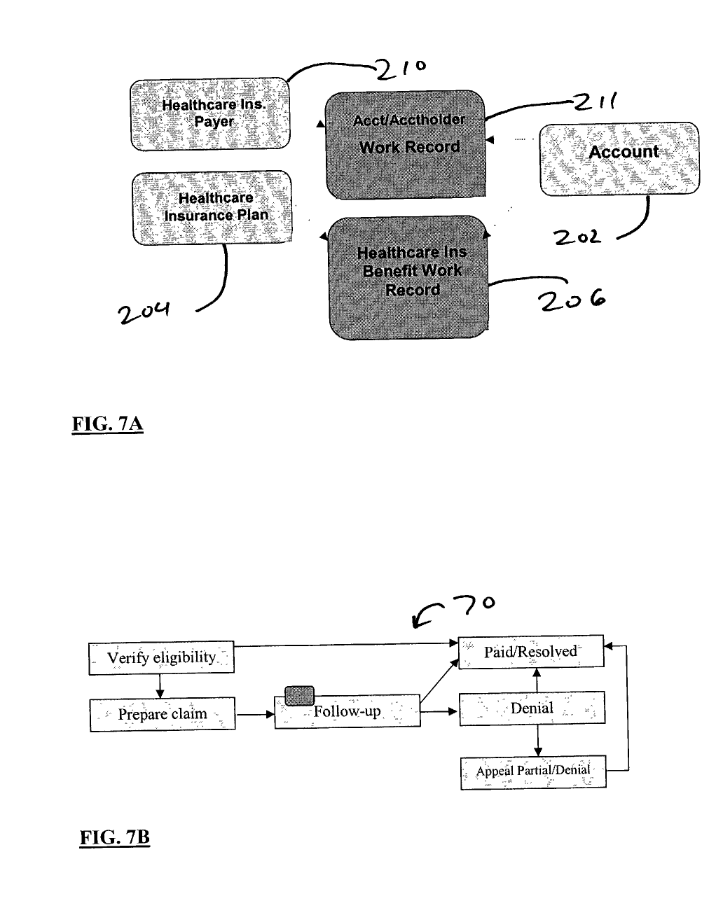

As discussed previously herein, at certain points during the life cycle of an account, additional information or work items might be created or derived from work currently being done to collect an account. FIGS. 7A-9B show examples of additional work items that are represented by work records in the Work Table and that also have an assigned workflow. According to the present invention, such additional work items represented by work records in the Work Table interoperate with the account management work record and sometimes also with one or more of the account/accountholder work records.

FIGS. 7A and 7B show an example of healthcare insurance claim workflow applied to a healthcare insurance claim work record. Shown in FIG. 7A are account record 202, healthcare insurance plan record 204, healthcare insurance claim work record 206, healthcare insurance payer record 210, and account/accountholder work record 211. Account/accountholder work record 211 and healthcare insurance claim work record 206 comprise data pertaining to the relationship between the accountholder information represented in healthcare insurance payer record 210, the account information represented in account record 202, and the healthcare insurance plan information in healthcare insurance plan record 204.

FIG. 7B shows a flow chart illustrating an exemplary healthcare insurance claim workflow 70 that may be applied to healthcare insurance claim work record 206 according to an implementation of the present invention. Healthcare insurance claim workflow 70 comprises the phases of verify eligibility, prepare claim, follow-up, denial, appeal partial payment or denial, and paid/resolved. In healthcare insurance claim workflow 70, the healthcare insurance claim work record has the “verify eligibility” phase as its initial phase. According to healthcare insurance claim workflow 70, the account leaves the verify eligibility phase by entering either the prepare claim phase or the paid/resolved phase. As designated by the location of the shaded block in FIG. 7B, healthcare insurance claim work record 206 is in the “follow-up” phase of healthcare insurance claim workflow 70.

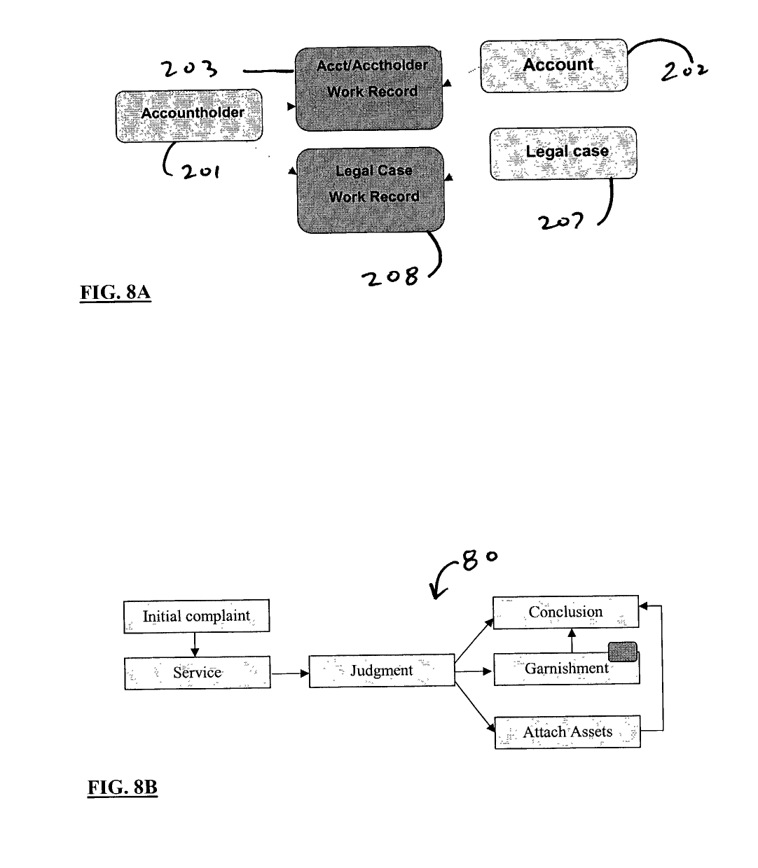

FIGS. 8A and 8B show an example of legal case workflow applied to a legal case work record. Shown in FIG. 8A are accountholder record 201, account record 202, account/accountholder work record 203, legal case record 207, and legal case work record 208. Work record 208 comprises data pertaining to the relationship between the accountholder information represented in accountholder record 201 and the legal case information in legal case record 207.

FIG. 8B shows a flow chart illustrating an exemplary legal case workflow 80 that may be applied to legal case work record 208 according to an implementation of the present invention. Legal case workflow 80 comprises the phases of initial complaint, service, judgment, attach assets, garnishment, and conclusion. In legal case workflow 80, the legal case work record has the “initial complaint” phase as its initial phase. According to legal case workflow 80, the account leaves the initial complaint phase by entering the service phase. As designated by the location of the shaded block in FIG. 8B, legal case work record 208 is in the “garnishment” phase of legal case workflow 80.

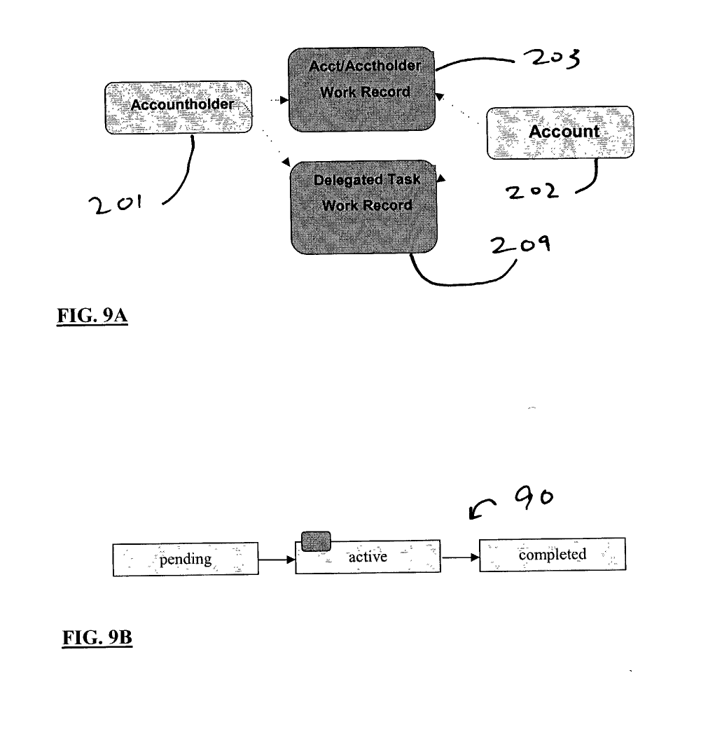

Work records also may be created to represent additional “tasks” that could be performed by an account collection representative, but not necessarily by the primary account collection representative. Such tasks are often delegated to clerical or support staff. FIGS. 9A and 9B show an example of a delegated task workflow applied to a delegated task work record. Shown in FIG. 9A are accountholder record 201, account record 202, account/accountholder work record 203, and delegated task work record 209. Work record 209 comprises data pertaining to the relationship between the accountholder information represented in accountholder record 201 and the account information in account record 202.

FIG. 9B shows a flow chart illustrating an exemplary delegated task workflow 90 that may be applied to delegated task work record 209 according to an implementation of the present invention. Delegated task workflow 90 comprises the phases of pending, active, and completed. In delegated task workflow 90, the delegated task work record has the “pending” phase as its initial phase. According to delegated task workflow 90, the account leaves the pending phase by entering the active phase. As designated by the location of the shaded block in FIG. 9B, delegated task work record 209 is in the “active” phase of delegated task workflow 90,.

According to the present invention, many different types of relationships can be represented by work records in the Work Table. The different workflows and different types of work associated with these different types of relationships are organized by the present invention using a feature of the present invention known as “role classes.” When a work record is created in the Work Table, it is assigned a role class. A role class may designate, for example, that the work record is for a single accountholder, or that the work record is for an account having multiple accountholders, or that the work record is for a healthcare insurance claim, or that the work record is for a legal case. A role class defines the valid configuration of database information that is being connected within a work record in the Work Table. That is, a role class defines for a work record, a listing of the pointers that must be populated with valid database record identifiers. For example, an “account/accountholder role class” of the present invention may indicate that the Account Holder Table must be linked as well as the Account Table. A “healthcare insurance claim role class” indicates that an account, a healthcare insurance claim, an accountholder (i.e., the healthcare insurance payer), and a healthcare insurance plan must be defined. The role class also determines, among other things, the workflow to be applied to the work record. Workflow is initiated on a work record based on the role class assigned to the work record. Note that there may be multiple workflows for each role class. However, each work record will have only one workflow and one role class.

A “role” is an instance of a role class. Each work record is assigned a role. The roles within a role class will often apply to different kinds of accounts, thereby allowing an automated collection system comprising the present invention to display different configurations of data (e.g., windows, screens, fields, etc.) on the client computer's video display, based on the role assigned to the work record. A configuration of a computer interface that is associated with a role may also be used to hide the inherent complexity of the other work records related to the account as well as the interoperating workflows for the different work records related to the account and any account extensions (such as healthcare insurance claims or legal cases). The association of computer interface configurations, tying methods, workflow determination methods, and event-handling methods further improves a role.

As discussed herein, multiple work records may be created in the Work Table for a single account. Each work record has its own workflow, which workflow is assigned according to the particular role class assigned to the work record. The present invention is operable to automatically interoperate workflows of different work records that relate to the same original account, even if the different work records have different role classes. Account management work records are assigned the “account management role class.” According to the present invention, the account management role class controls the creation (and potential destruction) of other Work Table records for other role classes that represent, for example, account/accountholders relationships and extensions of the account structure such as healthcare insurance claims and legal cases.

There are three ways in which the present invention facilitates the interoperation of workflows for a single account or financial obligation: (a) creating/destroying Work Table records, (b) changing the phase variable of an existing work record workflow, and (c) event handling. For example, a phase change in the workflow of the account management work record may cause work records having another role class to be created. Thus, for example, when the workflow on an account management work record is moved into a recovery phase (see, e.g., FIG. 5B), an automated collection system comprising the present invention can be configured to create a work record that represent the work of a recovery vendor, such as, for example, a third party collection agency or a collection attorney. In another example, when the workflow on an account management work record is moved to an inactive phase, the work record(s) representing the related account/accountholders relationships are also moved automatically to an inactive phase in their respective workflows.

Many times, events occur in the workflow of an account management work record (for example, an account is canceled, an account balance is changed, etc.) that cause changes to work records having other role classes and workflows such as, for example, an account/accountholder work record, a legal case work record, a healthcare insurance claim work record, etc. Alternatively, something might change in an account/accountholder work record (e.g., a new job, a bankruptcy, a change of address) that needs to trigger activity in other work records. When a significant event interrupts a workflow of a work record, the event handling routine(s) applicable to that event determines in which other work record workflows (according to role class) the present invention will need to change data. For example, an event may comprise the receipt of a notification that an accountholder has filed for bankruptcy. If the workflow on an account/accountholder work record then is moved to a “bankrupt” phase, the present invention's event handling routine(s) may be configured to automatically change data in the account management work record, the account/accountholder work record, the legal case work record, etc.

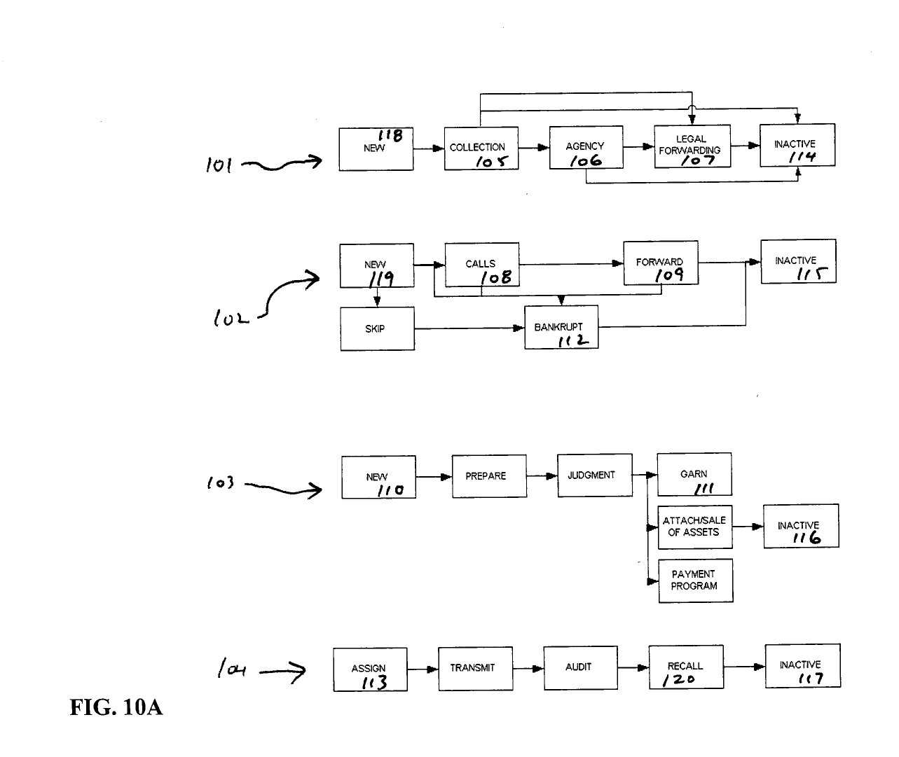

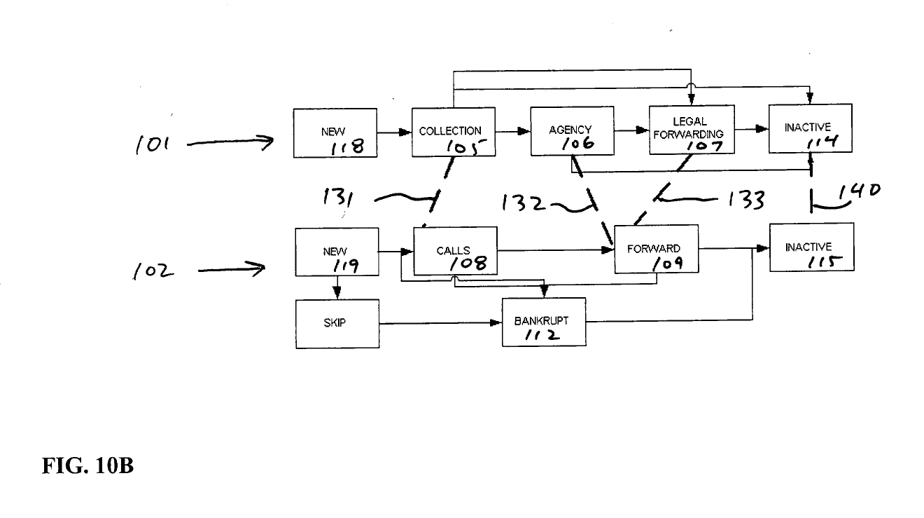

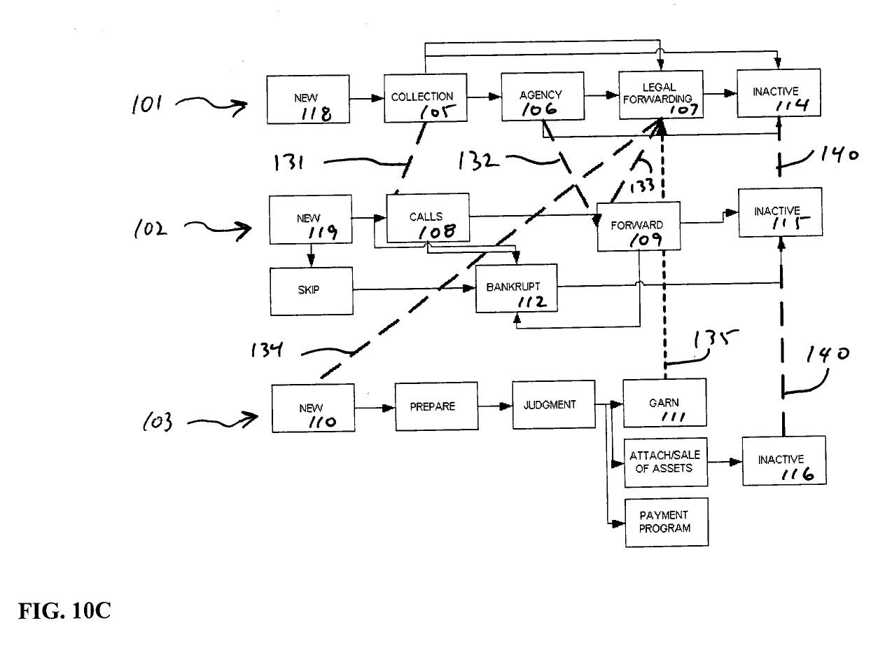

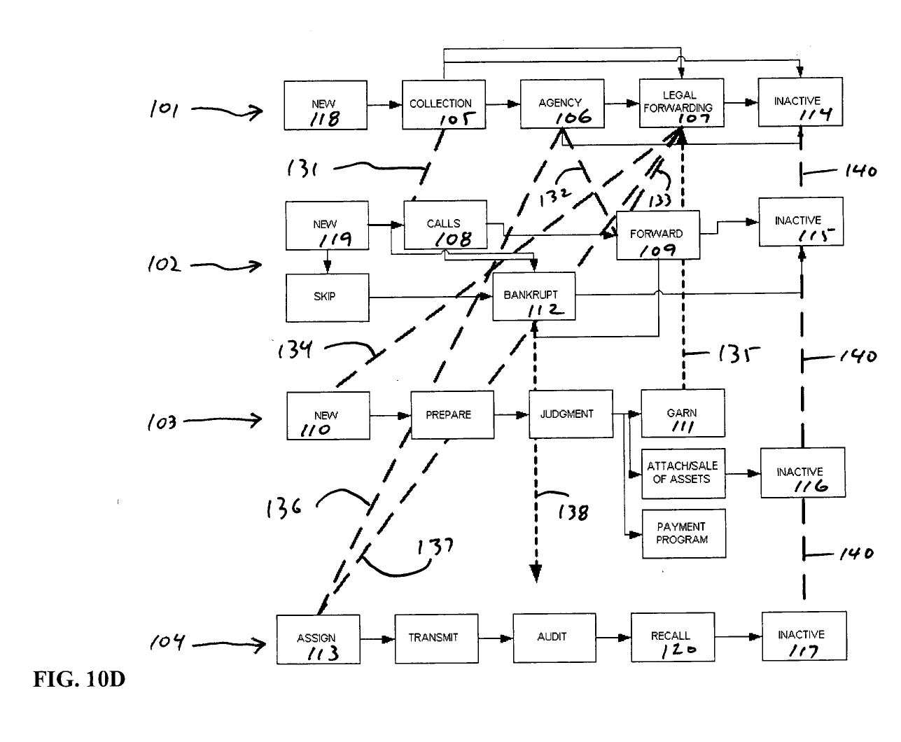

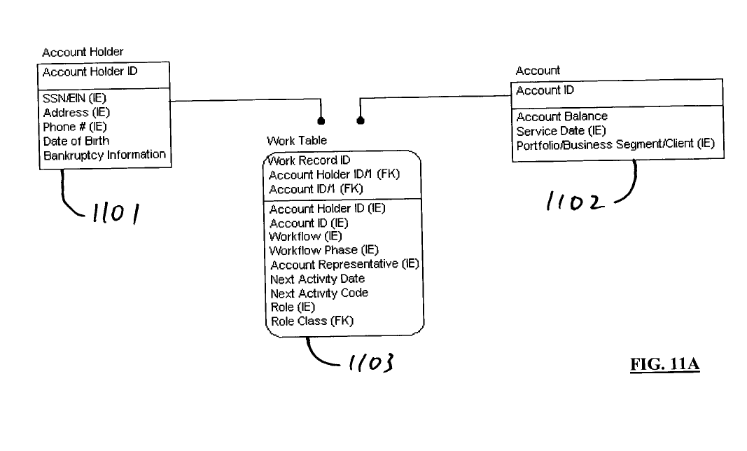

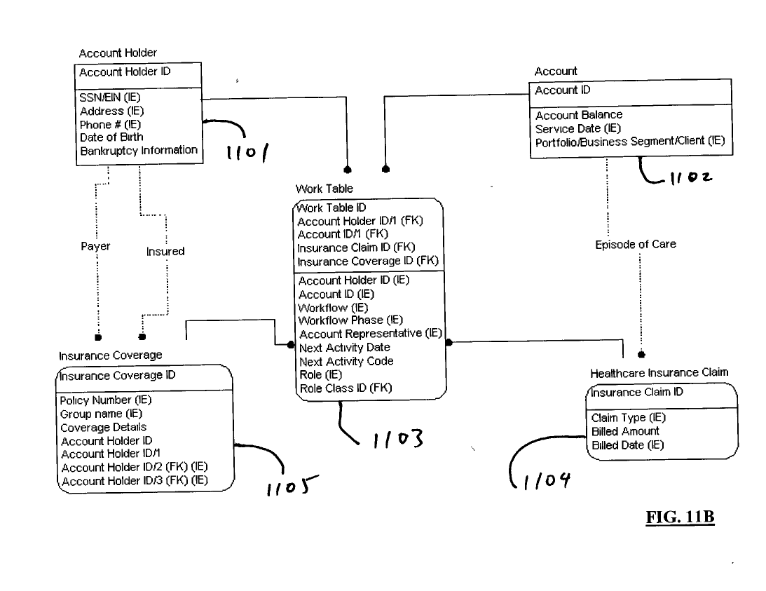

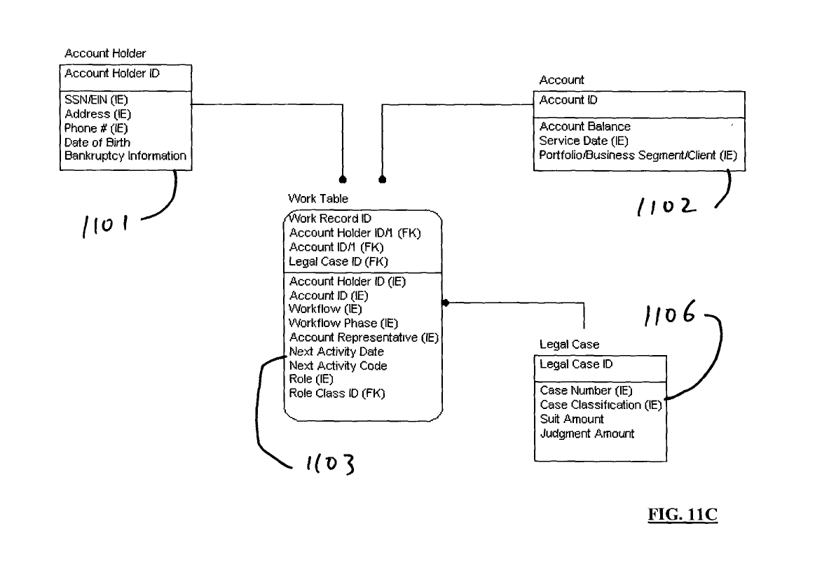

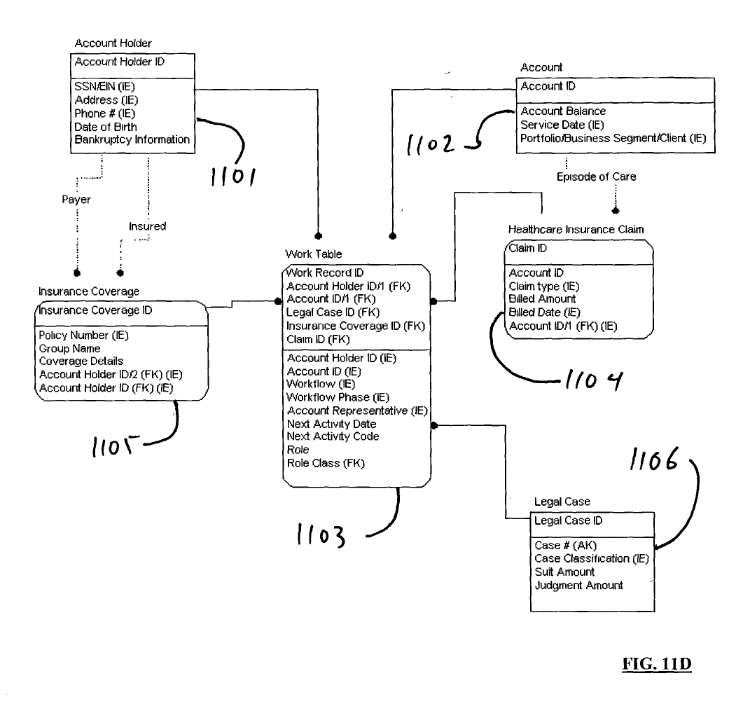

FIGS. 10A-D show an example of workflow interoperation according to the present invention. Shown in FIG. 10A are four work records: an account management work record, an account/account holder work record, a legal case work record, and a forwarding vendor work record. The Work Table records shown in FIGS. 10A-D are related to the same underlying account.

The account management work record comprises account management work workflow 101, which comprises new phase 118, collection phase 105, agency phase 106, legal forwarding phase 107, and inactive phase 114. The account/account holder work record comprises account/account holder workflow 102, which comprises new phase 119, calls phase 108, forward phase 109, bankrupt phase 112, and inactive phase 115. The legal case work record comprises legal case workflow 103, which comprises new phase 110, garnishment phase 111, and inactive phase 116. The forwarding vendor work record comprises forwarding vendor workflow 104, which comprises assign phase 113, recall phase 120, and inactive phase 117.

FIG. 10B shows the interoperation of account management workflow 101 and account/account holder workflow 102 in an embodiment of the present invention. Shown in FIG. 10B are actions 131, 132, 133, and 140, each depicted by a dashed line between two phases. As discussed previously, when a new record is received by an automated collection system comprising the present invention, an account management work record and at least one account/account holder work record are created in the Work Table. Each such work record is assigned a work flow, shown in FIGS. 10A-D as account management workflow 101 and account/account holder workflow 102, respectively. Each workflow is assigned an initial phase, shown in FIGS. 10A-D as new phase 118 and new phase 119, respectively.

Action 131 arises when the workflow phase of account management workflow 101 is changed from new phase 118 to collection phase 105. This embodiment of the present invention is operable thereafter to automatically change the workflow phase of account/account holder workflow 102 from new phase 119 to calls phase 108. An automated collection system comprising the present invention is operable, when account/account holder workflow 102 is in calls phase 108, to prompt an account collection representative to place one or more telephone calls to the accountholder identified in the account/account holder work record. For example, information from the account/account holder work record may appear on the video display means 12 of client computer 11, and a telephone dialer integrated with the automated collection system may then automatically place a call to the accountholder.

Action 132 of FIG. 10B arises when the workflow phase of account management workflow 101 is changed from collection phase 105 to agency phase 106. This embodiment of the present invention is operable thereafter to automatically change the workflow phase of account/account holder workflow 102 from calls phase 108 to forward phase 109. This change reflects the re-assignment of the collection effort from an internal account collection representative to an external account collection representative or other third party. An automated collection system comprising the present invention is operable, when account/account holder workflow 102 is moved to forward phase 109, to cease prompting the internal account collection representative to place telephone calls to the accountholder identified in the account/account holder work record. Instead, the account collection representative is instructed by the automated collection system to perform other tasks.

Action 133 of FIG. 10B arises when the workflow phase of account management workflow 101 is changed from collection phase 105 to legal forwarding phase 107. Note that this change bypasses agency phase 106, but is permitted according to account management workflow 101. This embodiment of the present invention is operable thereafter to automatically change the workflow phase of account/account holder workflow 102 from calls phase 108 to forward phase 109. This change reflects the re-assignment of the collection effort from an internal account collection representative to an external collection lawyer, who is authorized to file a collection lawsuit against the accountholder. An automated collection system comprising the present invention is operable, when account/account holder workflow 102 is moved to forward phase 109, to cease prompting the internal account collection representative to place telephone calls to the accountholder identified in the account/account holder work record. Instead, the internal account collection representative is instructed by the automated collection system to perform other tasks.

Action 140 of FIG. 10B arises when the workflow phase of account management workflow 101 is changed to inactive phase 114 from another workflow phase. This embodiment of the present invention is operable thereafter to automatically change the workflow phase of account/account holder workflow 102 to inactive phase 115, indicating to an automated collection system comprising the present invention that collection activity on the account has ceased.

Referring now to FIG. 10C, there is shown account management workflow 101, account/account holder workflow 102, and legal case workflow 103. Also shown in FIG. 10C are actions 134 and 140, and event 135, which together show the interoperation of account management workflow 101 and legal case workflow 103 in an embodiment of the present invention.

Action 134 of FIG. 10C arises when the workflow phase of account management workflow 101 is changed to legal forwarding phase 107 from another workflow phase. This embodiment of the present invention is operable thereafter to automatically create a legal case work record and to assign it legal case workflow 103. Legal case workflow 103 is assigned new phase 110 upon its creation. This change reflects the re-assignment of the collection effort from an internal account collection representative to an external collection lawyer, and the authorization of the external collection lawyer to initiate a collection lawsuit.

Event 135 of FIG. 10C arises when the workflow phase of legal case workflow 101 is changed to garnishment phase 111. This change reflects the issuance of a court order garnishing the wages of the accountholder. This embodiment of the present invention is operable thereafter to automatically record the successful garnishment action to the account management work record, which is in legal forwarding phase 107 at the time.

Action 140 of FIG. 10C arises when the workflow phase of account management workflow 101 is changed to inactive phase 114 from another workflow phase. This embodiment of the present invention is operable thereafter to automatically change the workflow phase of legal case workflow 103 to inactive phase 116, indicating to an automated collection system comprising the present invention that collection activity on the account has ceased.

Referring now to FIG. 10D, there is shown account management workflow 101, account/account holder workflow 102, legal case workflow 103, and forwarding vendor workflow 104. Also shown in FIG. 10D are actions 136, 137, and 140, and event 138, which together show the interoperation of account management workflow 101, account/accountholder workflow 102, and forwarding vendor workflow 104 in an embodiment of the present invention.

Action 136 of FIG. 10D arises when the workflow phase of account management workflow 101 is changed from collection phase 105 to agency phase 106. This embodiment of the present invention is operable thereafter to automatically create a forwarding vendor work record and to assign it forwarding vendor workflow 104. Forwarding vendor workflow 104 is assigned new phase 113 upon its creation. Action 136 reflects the re-assignment of the collection effort from an internal account collection representative to an external account collection representative or other third party debt collector. The forwarding vendor work record is used by an automated collection system comprising the present invention to track the activities of such an external account collection representative or other third party debt collector. One forwarding vendor work record is created in the Work Table for each account assigned, even if a plurality of accounts are assigned to the same external account collection representative or other third party debt collector.

Action 137 of FIG. 10D arises when the workflow phase of account management workflow 101 is changed to legal forwarding phase 107. This embodiment of the present invention is operable thereafter to automatically create a forwarding vendor work record and to assign it forwarding vendor workflow 104. Forwarding vendor workflow 104 is assigned new phase 113 upon its creation. Action 137 reflects the reassignment of the collection effort to an external collection lawyer, and the authorization of the external collection lawyer to initiate a collection lawsuit. Action 137 is executed in conjunction with action 134. As noted previously, one forwarding vendor work record is created in the Work Table for each account assigned, even if a plurality of accounts are assigned to the same collection lawyer. Similarly, a first forwarding vendor work record is created if the account is assigned to an external collection agency, and a second forwarding vendor work record is created if the account is assigned thereafter to an external collection lawyer.

Event 138 of FIG. 10D arises when the workflow phase of account/accountholder workflow 102 is changed to bankrupt phase 111. This change reflects the receipt of information that the accountholder has been found to be bankrupt. This embodiment of the present invention is operable thereafter to assign the workflow phase of forwarding vendor workflow 104 to recall phase 120. The external account collection representative, collection lawyer, or other third party to whom the account was assigned for collection then is contacted and instructed to cease work on the account collection. Contact may be made automatically by the automated collection system via electronic data interchange or other means, or by a human account collection representative via telephone or e-mail. After the external account collection representative, collection lawyer, or other third party has ceased work on the account, the workflow phase of forwarding vendor workflow 104 is assigned inactive phase 117. Note that assigning the workflow phase of forwarding vendor workflow 104 to inactive phase 117 does not mean that the workflow phase of account management workflow 101 is necessarily assigned to inactive phase 114.

Action 140 of FIG. 10D arises when the workflow phase of account management workflow 101 is changed to inactive phase 114 from another workflow phase. This embodiment of the present invention is operable thereafter to automatically change the workflow phase of forwarding vendor workflow 104 to inactive phase 117, indicating to an automated collection system comprising the present invention that collection activity on the account has ceased.

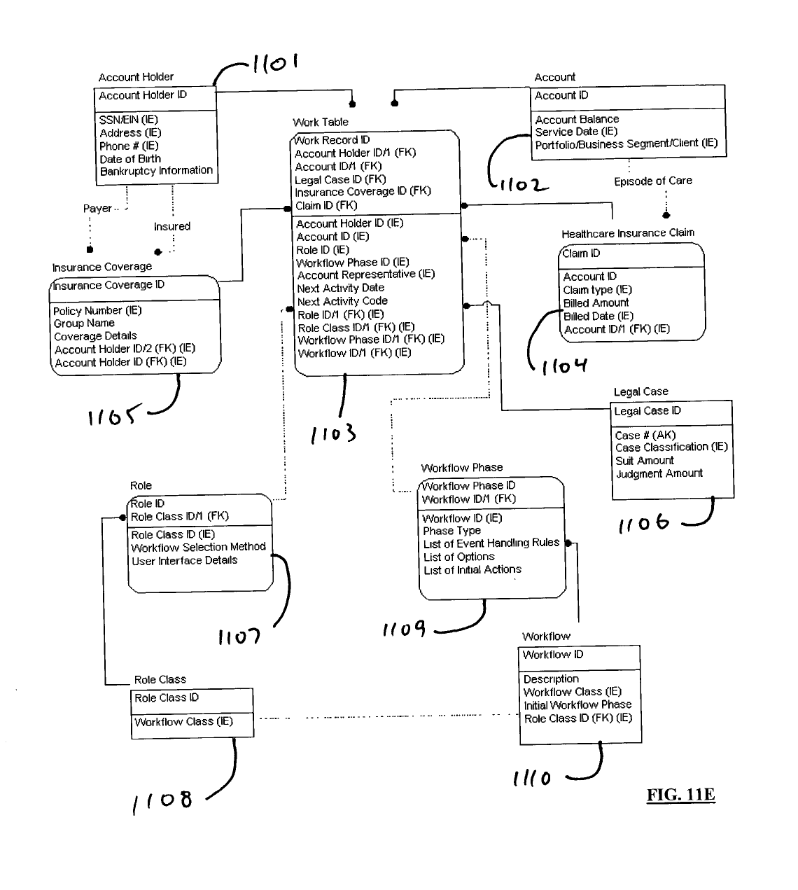

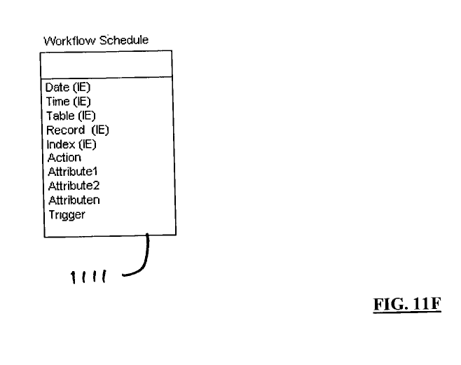

FIGS. 11A-F show a series of entity relationship diagrams (“ERD”) illustrating several embodiments of the data model of the present invention. FIGS. 11A-F are drawn in accordance with the IDEFIX ERD conventions. In FIGS. 11A-F, “(FK)” designates a “foreign key,” “(IE)” designates an “indexed field,” and “(AK)” designates an “alternate key.” Lines denote relationships between two entities (for example, database tables). Filled circles at one or both ends of such lines indicate cardinality. Dependent entities have rounded comers.

As discussed herein, the data model of the present invention provides a separation between the account and the accountholders. A Work Table represents the connection between accounts and accountholders. This data structure allows the representation of many-to-many relationships as well as the tracking of each accountholder in the collection process individually if so desired.

Each data structure in the data model contains data attributes that belong to the entity represented by that data structure. A few such attributes are shown on the diagrams in FIGS. 11A-F. The attributes critical to the operation of the data model of the present invention and its integration with role class and workflow are shown, along with a few other attributes indicative of the type of data stored in each data structure.

FIG. 11A shows an embodiment of a data model according to the present invention comprising Account Holder Table 1101, Account Table 1102, and Work Table 1103. Work Table 1103 contains the key to Account Holder Table 1101 (accountholder ID) and Account Table 1102 (account ID). If an account has three co-responsible accountholders, there are three work records in Work Table 1103 that express the account/accountholder relationship. Each of the three work records contains the same account ID, but different accountholder IDs.

The foreign keys on Work Table 1103 provide access to the data attributes of the related data structures when processing the work records. This means, for example, that an accountholder's SSN is available when processing a work record that contains the key to Account Holder Table 1101, even though the accountholder's SSN does not itself appear in the work record.

Work Table 1103 shown in FIG. 11A contains attributes associated with workflow and working receivables. These include: workflow, workflow phase, account representative, next activity date, and next activity code. The role class and role attribute also are identified on Work Table 1103.

The data structure shown in FIG. 11A is directed toward a process in which accountholders are contacted directly to create payment arrangements. When this data structure is extended to include supplemental collection processes, Work Table 1103 points to additional data structures. For example, depending on the nature of the debt, a healthcare insurance claim data structure, a healthcare insurance coverage data structure, and a legal case data structure may be added. Other data structures may be added to this data model to represent other aspects of receivables management as well.

FIG. 11B shows the data model of FIG. 11A, as adapted for use in a healthcare insurance claim collection scenario. Insurance Coverage Table 1105 contains details about the accountholder's coverage with the healthcare insurance plan such as: policy number, group name and number, and other coverage details. Healthcare Insurance Claim Table 1104 contains details about the healthcare insurance claim. In a work record according to this data model, the role class attribute will identify the work record as a healthcare insurance claim involving a third party payer.

FIG. 11C shows the data model of FIG. 11A as adapted for collection litigation. Legal Case Table 1106 contains a case number issued by the court system, a case classification (which may be significant in workflow selection for the legal case role class), a suit amount, and a judgment amount and date. Legal Case Table 1106 of FIG. 11C describes data attributes of a legal case that is being brought against one or more accountholders as defendants for one or more accounts. Legal Case Table 1106 has a logical dependence on Account Table 1102, but since the legal case might exist in a many-to-many relationship with Account Table 1102, Work Table 1103 is used to represent that complex relationship. Accordingly, an automated collection system comprising the present invention can easily track multiple lawsuits being brought to recover a single account balance; and multiple accounts that might be combined into a single lawsuit. A work record comprising a role class attribute identifying it as a legal case will point to a defendant (accountholder ID) and a legal case (legal case ID).

FIG. 11D shows the data model of FIG. 11A adapted for both healthcare insurance claims and collection litigation. Shown in FIG. 11D are Account Holder Table 1101, Account Table 1102, Work Table 1103, Healthcare Insurance Claim Table 1104, Insurance Coverage Table 1105, and Legal Case Table 1106. Work Table 1103 contains keys to each of these data structures (e.g., claim ID, insurance coverage ID, and legal case ID). Work Table 1103 inherits foreign keys from the supplemental data structures.

The Healthcare Insurance Claim Table 1104 of FIG. 11D indicates a dependency on the episode of care data from Account Table 1102. This data structure provides information about the episode of care that facilitates follow-up on a particular healthcare insurance claim. The claim is associated with a particular episode of care (account ID), billed amount and date, and type of claim.

The Insurance Coverage Table 1105 in FIG. 11D indicates a dependency on the Accountholder Table. In this case, there are two entities associated with an insurance coverage: the healthcare insurance payer (on behalf of the patient/accountholder) and the insured party (accountholder).

FIG. 11E shows the data model of FIG. 11D as embellished to show Role Table 1107, Role Class Table 1108, Workflow Phase Table 1109, and Workflow Table 1110. This diagram depicts the connection(s) between the data structures that house the production data for an automated collection system comprising the present invention (such as accounts records, accountholder records, legal case records, insurance coverage records, and work records) and the data structures that house role class, role, and workflow data for the automated collection system comprising the present invention.

Role class and workflow class relate the role and workflow data structures. This connection allows a practitioner of the present invention to specify appropriate workflow sets for each role class. The role determines the workflow determination script that is executed when a work record for that role is created. The workflow determination script determines which workflow is associated to a work record. After the workflow is associated to the work record and the initial phase of that workflow is started on the work record, and any initial phase actions are executed or scheduled.

FIG. 11F shows the data structure for Workflow Schedule Table 1111 according to the present invention. An operational result of workflow is a list of scheduled system actions for a work record. These actions result from known scheduled actions for a workflow phase or result from events that occur while the work record is within a workflow phase. The workflow and phase IDs on the work record enable the system to accurately select actions to schedule for the work record. Once actions have been scheduled, a workflow monitor program executes actions as their scheduled time becomes current. Actions may depend on attributes, as shown in FIG. 11F. Once an action has been executed on the record, a log of that action is logged into the workflow history for the record.

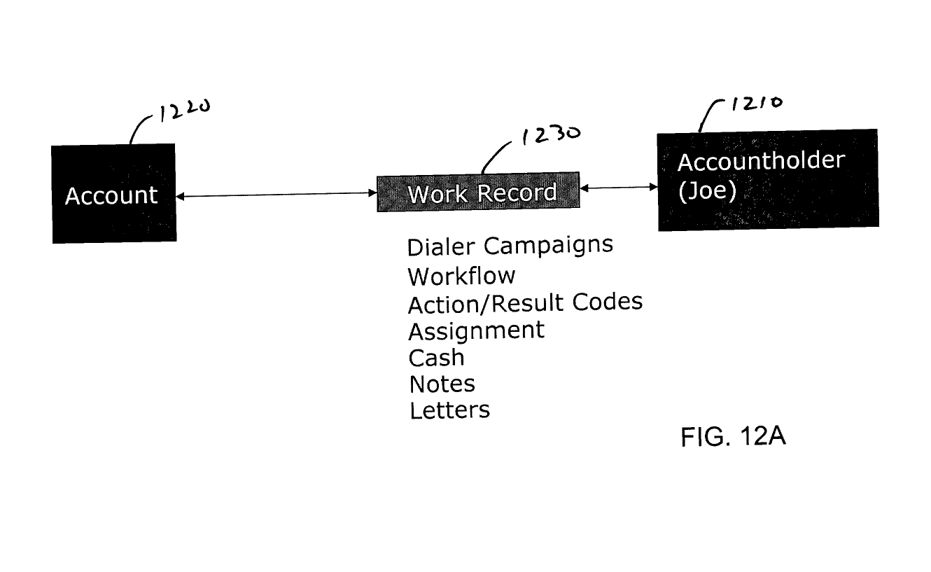

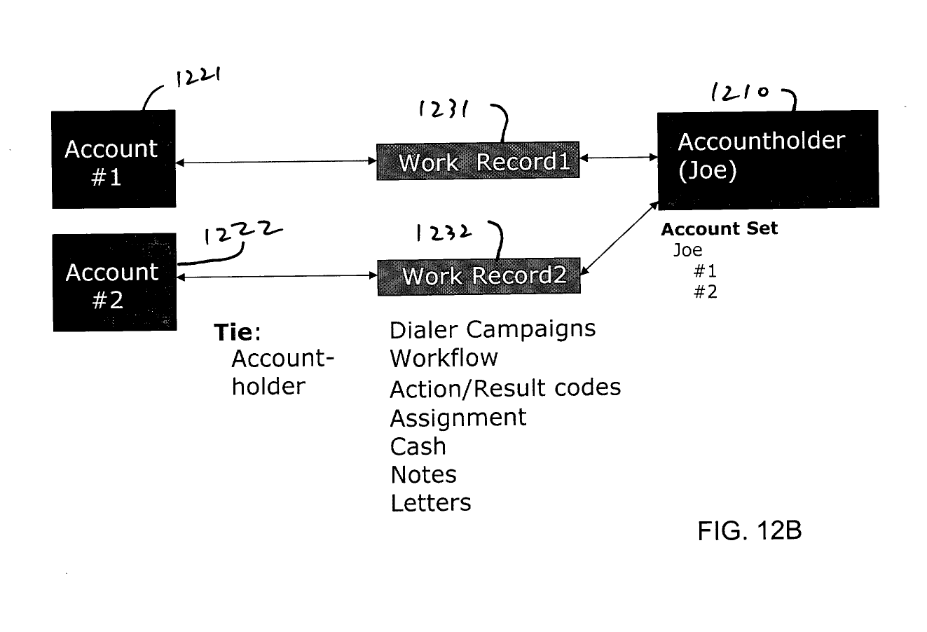

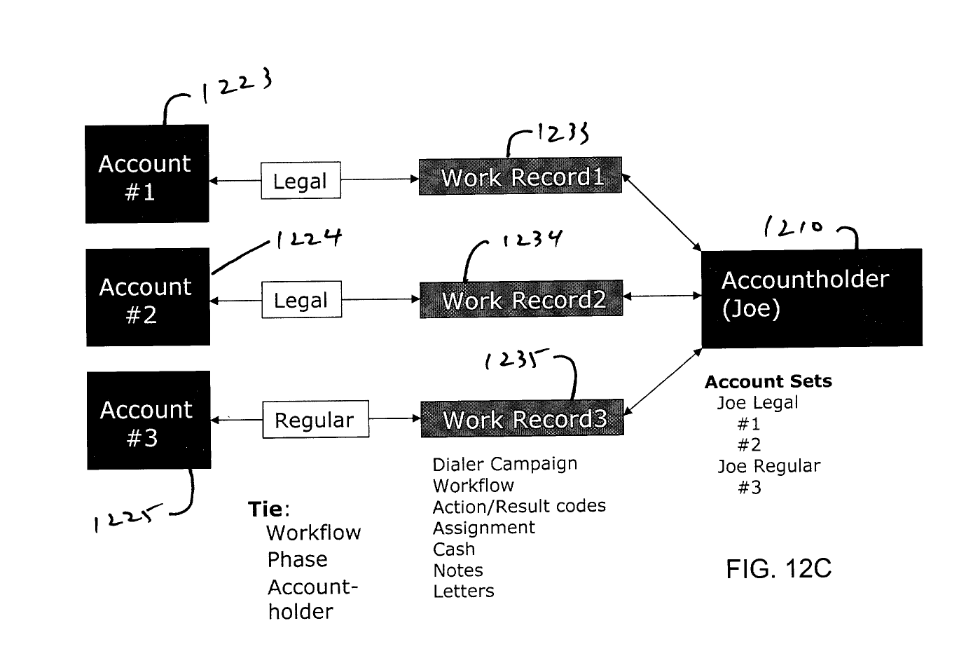

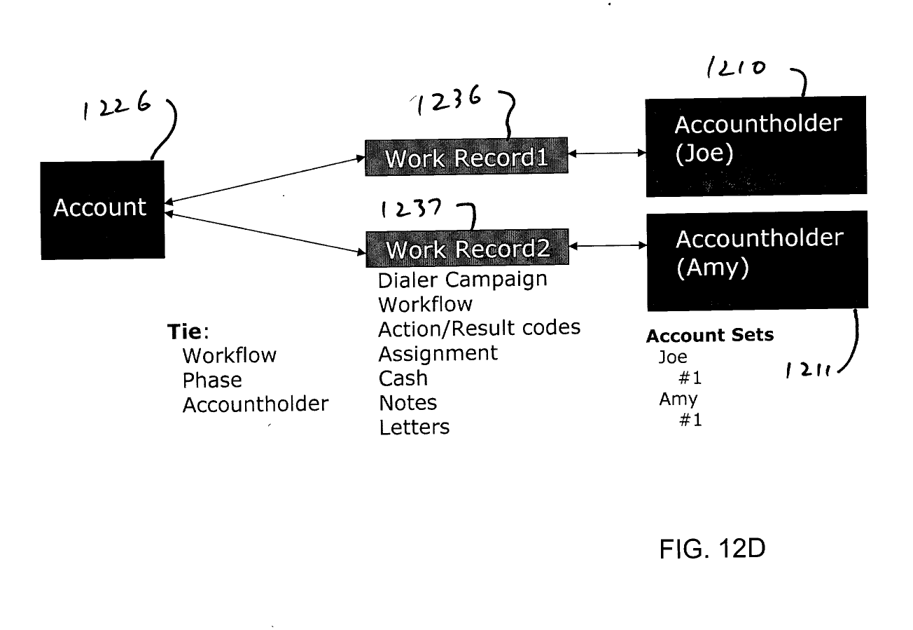

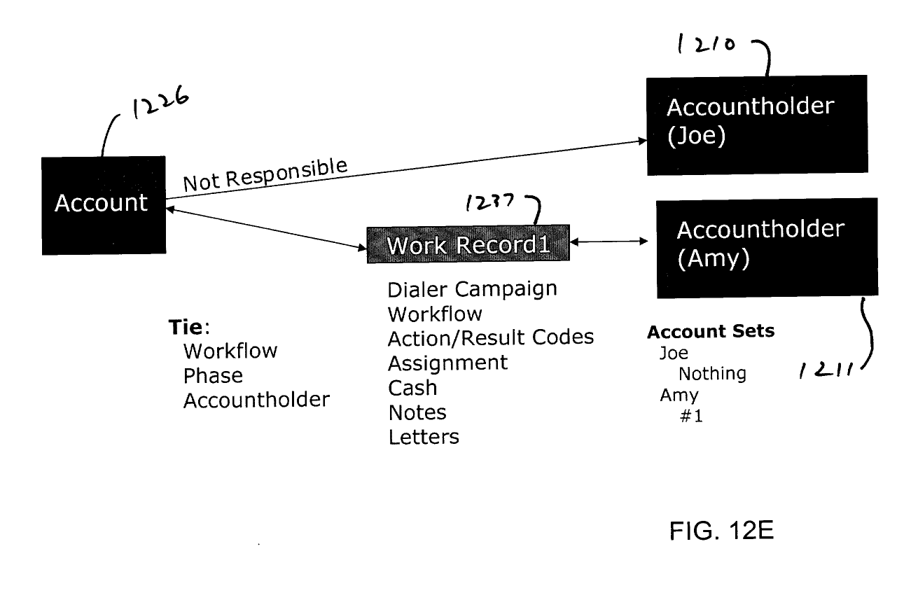

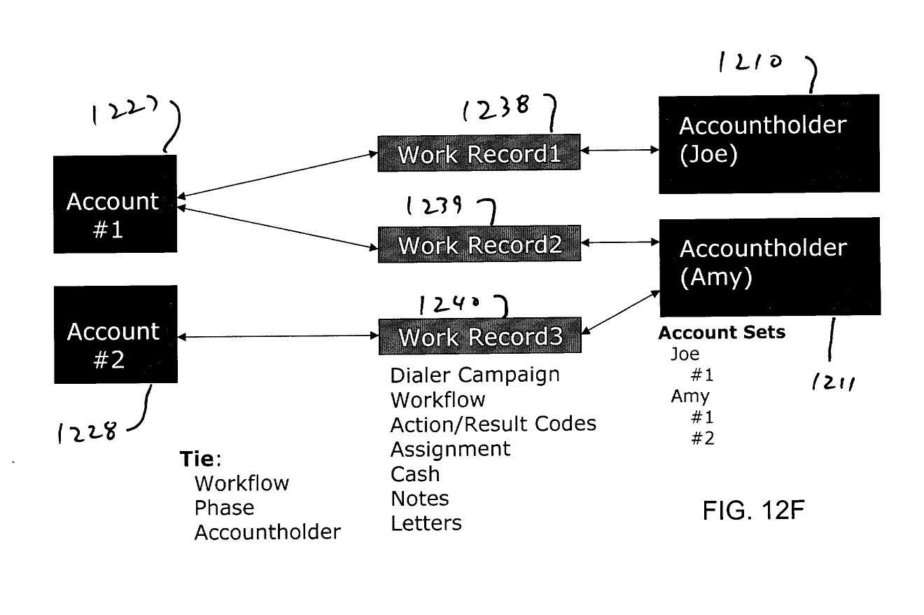

FIGS. 12A-F show block diagrams illustrating implementations of the present invention. The implementations shown in FIGS. 12A-F illustrate the flexibility of the data model according to the present invention.

Referring now to FIG. 12A, there is shown a block diagram illustrating an example of an implementation of the present invention. Shown in FIG. 12A is accountholder record 1210 labeled “Accountholder (Joe),” account record 1220 labeled “Account,” and work record 1230 labeled “Work Record.” Also shown in FIG. 12A is a plurality of system functions listed below work record 1230. The system functions listed in FIG. 12A operate based on data present in the Work Table of the present invention, or data which is accessed by the Work Table through its relation to the other data structures in the data model (such as the Account Table and the Account Holder Table). Each of these system functions comprises software programs, including scripts and macros, which are operable to cause the system to perform certain actions. For example, the “Dialer Campaigns” function prioritizes for an account collection representative the telephone numbers to be dialed for contacting accountholders. The “Workflow” system function comprises the operability to move the work record from one workflow phase to another. The “Action/Result Codes” system function comprises information entered by a collection representative based on activities taken by the collection representative for working. The “Assignment” system function is operable to assign the work record to a particular collection representative. The “Cash” system function is operable to post financial transactions against an account balance. The “Notes” system function is operable to receive free form text input, and can work in conjunction with the Action/Result Codes system function. The “Letters” system function is operable to automatically generate letters, legal documents, and other printed materials.

Referring now to FIG. 12B, there is shown a block diagram illustrating another example of an implementation of the present invention. The implementation shown in FIG. 12B comprises account records 1221 and 1222, work records 1231 and 1232, but only one accountholder record 1210. This indicates that the same accountholder is obligated on two different accounts. Note that in this implementation, the work records are tied based on the common accountholder. Also note that the same system functions are available in this implementation as were available in the implementation shown in FIG. 12A.

Referring now to FIG. 12C, there is shown a block diagram illustrating an implementation of the present invention comprising account records 1223, 1224, and 1225, work records 1233, 1234, and 1235, but only one accountholder record 1210. Tying is done in this implementation according to workflow assigned to the work record, the workflow phase identified in the work record, and the accountholder. Note that according to this implementation, this tying scheme results in two sets of accounts. The first set consists of work records 1233 and 1234. The second set consists of only work record 1235. Also note that the same system functions are available in this implementation as were available in the other implementations shown in FIGS. 12A-B.

Referring now to FIG. 12D, there is shown a block diagram illustrating an implementation of the present invention in which two accountholders are obligated on a single account. Shown in FIG. 12D are account record 1226, work records 1236 and 1237, and accountholder records 1210 and 1211. Tying is performed in FIG. 12D according to workflow, phase, and accountholder. As a result of the tying scenario of FIG. 12D, two account sets are identified. Note that, despite the different relationships shown in FIG. 12D, the same system functions are available.

Referring now to FIG. 12E, there is shown a block diagram illustrating the implementation of FIG. 12D, after it has been determined that one of the accountholders is not responsible for the account. Accordingly, the workflow of work record 1236 is changed to an “inactive” phase, and work record 1236 is untied from its account set. Only one work record 1237 is shown to reflect the remaining accountholder obligation.

Referring now to FIG. 12F, there is shown a block diagram illustrating another implementation of the present invention. Shown in FIG. 12F are account records 1227 and 1228, work records 1238, 1239, and 1240, and accountholder records 1210 and 1211. Work record 1238 reflects the relationship between accountholder record 1210 and account record 1227. Work record 1239 reflects the relationship between accountholder record 1211 and account record 1227. Work record 1240 reflects the relationship between accountholder record 1211 and account record 1228. Tying is performed in this implementation according to workflow, phase, and accountholder. Accordingly, two account sets are shown. The first account set comprises work record 1238. The second account set comprises work records 1239 and 1240.

Although discussed herein in terms of an automated collection system embodiment, the present invention is not limited to the automated collection systems field. Indeed, the data model of the present invention may be adapted for other systems wherein a work item to be tracked is separable from resources to perform the work. For example, an embodiment of the present invention may be adapted for a law firm representing one or more plaintiffs in one or more lawsuits, such as, for example, a law firm focusing on plaintiffs personal injury or medical malpractice cases. Each such plaintiffs case is analogous to an “account,” as that term is used in the debt collection embodiment hereof Each defendant or potential defendant is analogous to an “accountholder,” as that term is used in the debt collection embodiment hereof. A Work Table in a law firm embodiment comprises work records reflecting various relationships between a plaintiffs case and each defendant or potential defendant. Other work records may be created, for example, to track the efforts of defendant's attorneys, private detectives, witnesses, expert witnesses, and the like. Role classes and workflows (including phases) can be developed for such work records, as appropriate. In addition, related work records may be created, updated, and destroyed by actions and events defined for workflows and phases of this embodiment.

In another example, an embodiment of the present invention may be adapted for a health care provider, such as a hospital having a plurality of units each providing a different health care service. Each unit of such a hospital is analogous to an “accountholder,” as that term is used in the debt collection embodiment hereof. Each patient served by the health care unit is analogous to an “account,” as that term is used in the debt collection embodiment hereof. A Work Table in a health care provider embodiment comprises work records reflecting various relationships between a health care unit and each patient. Role classes and workflows (including phases) can be developed for such work records, as appropriate. In addition, related work records may be created, updated, and destroyed by actions and events defined for workflows and phases of this embodiment.

In yet another example, an embodiment of the present invention may be adapted for an entity engaged in assigning its resources (such as people or machines) to one or more projects. Each resource is analogous to an “accountholder,” as that term is used in the debt collection embodiment hereof. Each project is analogous to an “account,” as that term is used in the debt collection embodiment hereof. A Work Table in a project performance embodiment comprises work records reflecting various relationships between resources and projects. Role classes and workflows (including phases) can be developed for such work records, as appropriate. In addition, related work records may be created, updated, and destroyed by actions and events defined for workflows and phases of this embodiment.

While this invention has been described as having a preferred design, the present invention can be further modified within the scope and spirit of this disclosure. This application is therefore intended to cover any variations, uses, or adaptations of the invention using its general principles. For example, the methods disclosed herein and in the appended claims represent one possible sequence of performing the steps thereof. A practitioner of the present invention may determine in a particular implementation of the present invention that multiple steps of one or more of the disclosed methods may be combinable, or that a different sequence of steps may be employed to accomplish the same results. Each such implementation falls within the scope of the present invention as disclosed herein and in the appended claims. Furthermore, this application is intended to cover such departures from the present disclosure as come within known or customary practice in the art to which this invention pertains.

We claim:

1. A method of implementing a debt collection process using a computer having a memory, the method comprising the steps of:
providing a first data structure in said memory, said first data structure comprising an account record, said account record comprising information about a debt;
providing a second data structure in said memory, said second data structure comprising at least one accountholder record, each said at least one accountholder record comprising information about a debtor that may be obligated to pay said debt;
providing a third data structure in said memory; and
processing said account information to create, in said third data structure, an account management record, said account management record comprising information related to said account record.

2. The method of claim 1, further comprising the step of:
processing said accountholder information and said account information to link said accountholder information to said account information in said third data structure, said third data structure thereafter comprising relationship data about one or more relationships between said account record and said at least one accountholder records.

3. The method of claim 2, wherein said processing step comprises the step of:
creating, in said third data structure, an account/accountholder record, said account/accountholder record comprising information related to said account record and one of said at least one accountholder records.

4. The method of claim 1, wherein said debt is a healthcare debt for which a healthcare insurance payer may be obligated to pay pursuant to a healthcare insurance plan, and wherein said second data structure comprises at least one accountholder record comprising information about said healthcare insurance payer, the method further comprising the steps of:
providing a fourth data structure in said memory, said fourth data structure comprising at least one healthcare insurance plan record comprising information about said healthcare insurance plan; and
processing said healthcare insurance plan information, said accountholder information about said healthcare insurance payer, and said account information to link said healthcare insurance plan information, said accountholder information about said healthcare insurance payer, and said account information in said third data structure, said third data structure thereafter comprising relationship data about one or more relationships between said account record, said at least one accountholder record comprising information about said healthcare insurance payer, and said at least one healthcare insurance plan record.

5. The method of claim 4, wherein said processing step comprises the step of:
creating, in said third data structure, a healthcare insurance claim record, said healthcare insurance claim record comprising information related to said account record, one of said at least one accountholder record comprising information about said healthcare insurance payer, and one of said at least one healthcare insurance plan records.

6. The method of claim 1, further comprising the steps of:
providing a fourth data structure in said memory, said fourth data structure comprising at least one legal case record, each said at least one legal case record comprising information about a collection lawsuit initiated for the purpose of collecting said debt, wherein at least one of said at least one accountholders is identified as a defendant in said collection lawsuit; and
processing said collection lawsuit information, said accountholder information, and said account information to link said collection lawsuit information, said accountholder information, and said account information in said third data structure, said third data structure thereafter comprising relationship data about one or more relationships between said account record, said at least one accountholder records, and said at least one legal case records.

7. The method of claim 6, wherein said processing step comprises the step of:
creating, in said third data structure, a legal case work record, said legal case work record comprising information related to said account record, one of said at least one accountholder records, and one of said at least one legal case records.

8. The method of claim 1, further comprising the step of:
assigning an account management workflow to said account management record, said account management workflow comprising information pertaining to at least one account management workflow phase, wherein each said at least one account management workflow phase is reflective of a possible step in said debt collection process, and wherein said account management workflow phase comprises an account management workflow phase variable that is capable of being assigned a value, said value assigned to said account management workflow phase variable being indicative of one of said at least one account management workflow phases.

9. The method of claim 8, where said account management record comprises a first work record, the method further comprising the step of:
creating a second work record in said third data structure, said second work record being created upon said account management workflow phase variable being assigned a value that is equal to a predetermined value.

10. The method of claim 8, where said account management record comprises a first work record, the method further comprising the step of:
deleting a second work record in said third data structure, said second work record being deleted upon said account management workflow phase variable being assigned a value that is equal to a predetermined value.

11. The method of claim 8, where said account management record comprises a first work record, the method further comprising the steps of:
providing a second work record in said third data structure, said second work record comprising data; and
changing said data of said second work record upon said account management workflow phase variable being assigned a value that is equal to a predetermined value.

12. The method of claim 1, wherein said third data structure comprises a plurality of work records, the method further comprising the steps of:
assigning a work record workflow to one of said plurality of work records, said work record workflow comprising information pertaining to at least one work record workflow phase, wherein each said at least one work record workflow phase is reflective of a possible step in said debt collection process, and wherein said work record workflow phase comprises a phase variable that is capable of being assigned a value, said value assigned to said phase variable being indicative of one of said at least one work record workflow phases; and
recording an event in said third data structure, wherein said recordation automatically changes the value of said phase variable.

13. The method of claim 1, wherein said third data structure comprises a plurality of work records, the method further comprising the steps of:
assigning a first work record workflow to a first of said plurality of work records, said first work record workflow comprising information pertaining to at least one first work record workflow phase, wherein each said at least one first work record workflow phase is reflective of a possible step in said debt collection process, and wherein said first work record workflow phase comprises a first work record workflow phase variable that is capable of being assigned a value, said value assigned to said first work record workflow phase variable being indicative of one of said at least one first work record workflow phases;
assigning a second work record workflow to a second of said plurality of work records, said second work record workflow comprising information pertaining to at least one second work record workflow phase, wherein each said at least one second work record workflow phase is reflective of a possible step in said debt collection process, and wherein said second work record workflow phase comprises a second work record workflow phase variable that is capable of being assigned a value, said value assigned to said second work record workflow phase variable being indicative of one of said at least one second work record workflow phases; and
changing said value of said first work record workflow phase variable, wherein said change in said value of said first work record workflow phase variable automatically causes a change in said value of said second work record workflow phase variable.

14. The method of claim 1, wherein said third data structure comprises a plurality of work records, the method further comprising the steps of:
assigning a work record workflow to one of said plurality of work records, said work record workflow comprising information pertaining to at least one work record workflow phase, wherein each said at least one work record workflow phase is reflective of a possible step in said debt collection process, and wherein said work record workflow phase comprises a phase variable that is capable of being assigned a value, said value assigned to said phase variable being indicative of one of said at least one work record workflow phases; and
changing said value of said phase variable, wherein said change in said phase variable value causes an action to be performed.

15. The method of claim 1, wherein said third data structure comprises a plurality of work records, the method further comprising the steps of:
assigning a work record workflow to one of said plurality of work records, said work record workflow comprising information pertaining to at least one work record workflow phase, wherein each said at least one work record workflow phase is reflective of a possible step in said debt collection process, and wherein said work record workflow phase comprises a phase variable that is capable of being assigned a value, said value assigned to said phase variable being indicative of one of said at least one work record workflow phases; and
changing said value of said phase variable, wherein said change in said phase variable value causes an action to be scheduled for future performance.

16. The method of claim 1, further comprising the step of:
recording an event in said third data structure, wherein said recordation automatically causes the creation of a work record.

17. The method of claim 1, further comprising the step of:
recording an event in said third data structure, wherein said recordation automatically causes an action to be performed.

18. The method of claim 1, further comprising the step of:
recording an event in said third data structure, wherein said recordation automatically causes an action to be scheduled for future performance.

19. An automated collection system comprising:
a computer having a memory;
a first data structure resident on said memory comprising account information about a debt;
a second data structure resident on said memory comprising accountholder information about at least one debtor that may be obligated to pay said debt;
a third data structure resident on said memory; and
processing structure capable of creating, in third data structure, an account management record, said account management record comprising information related to said account information.

20. The automated collection system of claim 19, further comprising:
processing structure capable of creating, in said third data structure, an account/accountholder record, said account/accountholder record comprising information about a relationship between said account information and said accountholder information about one of said debtors.

21. The automated collection system of claim 19, wherein said debt comprises a healthcare debt, and wherein at least one of said at least one debtors is a healthcare insurance payer that is obligated to pay said healthcare debt pursuant to a healthcare insurance plan, said system further comprising:
a fourth data structure resident on said memory, said fourth data structure comprising at least one healthcare insurance plan record comprising information about said healthcare insurance plan; and
processing structure capable of creating, in said third data structure, a healthcare insurance claim record, said healthcare insurance claim record comprising information about a relationship between said account information, accountholder information about one of said healthcare insurance payers, and said healthcare insurance plan information.

22. The automated collection system of claim 19, further comprising:
a fourth data structure resident in said memory, said fourth data structure comprising at least one legal case record, each said at least one legal case record comprising information about a collection lawsuit initiated for the purpose of collecting said debt, wherein at least one of said at least one debtors is identified as a defendant in said collection lawsuit; and
processing structure capable of creating, in said third data structure, a legal case work record, said legal case work record comprising information about a relationship between said account information, said accountholder information about one of said debtors, and said collection lawsuit information about one said collection lawsuit.
